(19) United States
(12) Patent Application Publication
(10) Pub. No.: US 2018/0197488 A1
(43) Pub. Date: Jul. 12, 2018

(54) DISPLAY DEVICE AND DISPLAY METHOD

(71) Applicant: SHARP KABUSHIKI KAISHA, Sakai City, Osaka (JP)

(72) Inventors: TOMOYUKI ISHIHARA, Sakai City (JP); KENTA FUKUOKA, Sakai City (JP)

(21) Appl. No.: 15/740,972

(22) PCT Filed: Jun. 24, 2016
(86) PCT No.: PCT/JP2016/068772

§ 371 Date: Dec. 29, 2017

(30) Foreign Application Priority Data
Jul. 3, 2015 (JP) 2015-134222

(51) Int. Cl. G09G 3/36; G02F 1/1335; G02F 1/1347

(52) U.S. Cl. CPC G09G 3/36; G02F 1/133528; G09G 2320/06; G02F 2201/16; G02F 2203/01; G02F 1/1347

(57) ABSTRACT

A display device that can display an image and make a background visible even when the image represented by a display gradation value and a transparency gradation value included in an image information signal is not within a displayable range is provided. Even when the image specified by the display gradation value and the transparency gradation value included in the image information signal is not within the displayable range, the display gradation value and the transparency gradation value can be adjusted by prioritizing the transparency gradation value or prioritizing the display gradation value. In this way, the display device can display the image, make the background transparent, and display the image and the background overlapping each other regardless of whether the image specified by the display gradation value and the transparency gradation value is within the displayable range.

### TECHNICAL FIELD

The present invention relates to a display device and a display method, and more particularly, to a display device that serves as a transparent display in which a background is transparent and a display method.

### BACKGROUND ART

In recent years, a display device that not only displays an image but also serves as a transparent display in which a background is transparent has been actively developing. For example, PTL 1 discloses a display device that includes a first liquid crystal panel capable of switching between a display state and a non-display state for each pixel and a second liquid crystal panel disposed on the back of the first liquid crystal panel. This display device controls the first and second liquid crystal panels as follows, based on an image information signal provided from the outside. The first liquid crystal panel causes a pixel to emit light in the display state and is transparent in the non-display state. The second liquid crystal panel changes optical transparency for each region. In this way, the display device can block light from one side by the second liquid crystal panel while displaying information on the first liquid crystal panel. Thus, the display device can display information by switching between a light-blocking display state that performs a light emission display without being affected by external light and a transparent display state in which a background is visible.

### CITATION LIST

### Patent Literature

PTL 1: JP 2008-83510 A

### SUMMARY OF INVENTION

### Technical Problem

However, the display device described in PTL 1 cannot display an image or make a background visible, based on an image information signal when the image represented by a display gradation value and a transparency gradation value included in the image information signal is not within a displayable range.

It is, therefore, an object of the present invention to provide a display device and a display method that can display an image and make a background visible even when the image represented by a display gradation value and a transparency gradation value included in an image information signal is not within a displayable range.

### Solution to Problem

In a first aspect of the present invention, a display device serves as a transparent display. The display device includes an image information signal conversion circuit, a display light-emitting light source, a selection ratio adjustment panel, and a transmittance adjustment panel. The image information signal conversion circuit is configured to obtain a selection ratio and a transmittance based on a display gradation value indicating a display gradation of an image and a transparency gradation value indicating transparency, the display gradation value and the transparency gradation value being included in an image information signal provided from the outside. The display light-emitting light source is configured to emit light source light. The selection ratio adjustment panel is configured to allow transmission of the light source light emitted from the display light-emitting light source and background light entering from a back side of the display device in proportions determined by the selection ratio. The transmittance adjustment panel is configured to allow transmission of at least the light source light or the background light at the transmittance, the light source light and the background light being transmitted through the selection ratio adjustment panel. The image information signal conversion circuit includes a calculation unit, a displayable range determination unit, and a gradation correction computing unit. The calculation unit is configured to calculate a total value of the display gradation value and the transparency gradation value. The displayable range determination unit is configured to determine whether the total value calculated by the calculation unit is greater than 1. The gradation correction computing unit is configured to obtain the selection ratio and the transmittance by using the transparency gradation value and the display gradation value according to transparency gradation value priority adjusting the display gradation value without changing the transparency gradation value or display gradation value priority adjusting the transparency gradation value without changing the display gradation value when the displayable range determination unit determines that the total value is greater than 1. The transparent display is configured to display at least an image or a background in proportions determined by the selection ratio and the transmittance.

In a second aspect of the present invention in the first aspect of the present invention, the gradation correction computing unit is configured to obtain the transmittance as 1 and the selection ratio based on the transparency gradation value when the selection ratio and the transmittance are obtained according to the transparency gradation value priority.

In a third aspect of the present invention in the first aspect of the present invention, the gradation correction computing unit is configured to obtain the transmittance as 1 and the selection ratio as a value equal to the display gradation value when the selection ratio and the transmittance are obtained according to the display gradation value priority.

In a fourth aspect of the present invention in any one of the first to third aspects, the gradation correction computing unit is configured to obtain the transmittance and the selection ratio by the same processing procedure based on the display gradation value and the transparency gradation value in both cases of the display gradation value priority and the transparency gradation value priority when the displayable range determination unit determines that the total value is less than or equal to 1.

In a fifth of the present invention in the first aspect of the present invention, the light source light emitted from the display light-emitting light source is monochromatic light.

In a sixth aspect of the present invention in the first aspect of the present invention, the display light-emitting light source is configured to emit the light source light in different colors one after another in time division manner for respective fields. The gradation correction computing unit is configured to obtain the selection ratio and the transmittance based on the transparency gradation value and the display gradation value corresponding to colors of the light source light for each of the fields.

In a seventh aspect of the present invention in the sixth aspect of the present invention, the plurality of fields further include a color mixture field in which the display light-emitting light source simultaneously emits light source light in at least two or more colors of the light source light from the different colors. The gradation correction computing unit is configured to adjust the selection ratio and the transmittance to obtain the display gradation value in the color mixture field less than or equal to a minimum display gradation value among the display gradation values of colors of the light source light.

In an eighth aspect of the present invention in the sixth or seventh aspect of the present invention, the transparency gradation value included in the image information signal is 0 or 1.

In a ninth aspect of the present invention in the first aspect of the present invention, the selection ratio adjustment panel includes a first liquid crystal panel and a first absorption polarizing plate adhering to a front surface of the first liquid crystal panel. The transmittance adjustment panel includes a second liquid crystal panel and a second absorption polarizing plate adhering to a front surface of the second liquid crystal panel. The first liquid crystal panel is configured to allow transmission of a polarization component having the same polarization direction as a direction of a transmission axis among polarization components of the light source light and/or the background light based on the selection ratio to enter the polarization component to the second liquid crystal panel. The second liquid crystal panel is configured to allow transmission of a polarization component having the same polarization direction as a direction of a transmission axis among polarization components of the light source light and/or the background light to a front side based on the transmittance.

In a tenth aspect of the present invention in the ninth aspect of the present invention, a radiation plate is further included, the radiation plate being configured to radiate the light source light emitted from the display light-emitting light source toward the front side while allowing transmission of the background light to the front side. The radiation plate is configured to enter the light source light and the background light to the first liquid crystal panel, a polarization direction of the light source light and a polarization direction of the background light being orthogonal to each other.

In an eleventh aspect of the present invention, a display method displays at least an image or a background on a display device serving as a transparent display. The display device includes an image information signal conversion circuit, a display light-emitting light source, a selection ratio adjustment panel, and a transmittance adjustment panel. The image information signal conversion circuit is configured to obtain a selection ratio and a transmittance based on a display gradation value indicating a display gradation of an image and a transparency gradation value indicating transparency, the display gradation value and the transparency gradation value being included in an image information signal provided from the outside. The display light-emitting light source is configured to emit light source light. The selection ratio adjustment panel is configured to allow transmission of the light source light emitted from the display light-emitting light source and background light entering from a back side of the display device in proportions determined by the selection ratio. The transmittance adjustment panel is configured to allow transmission of at least the light source light or the background light at the transmittance, the light source light and the background light being transmitted through the selection ratio adjustment panel. The display method includes calculating, displayable range determining, and gradation correction computing. The calculating that calculates a total value of the display gradation value and the transparency gradation value. The displayable range determining that determines whether the total value calculated by the calculation unit is greater than 1. The gradation correction computing that obtains the selection ratio and the transmittance by using the transparency gradation value and the display gradation value according to transparency gradation value priority adjusting the display gradation value without changing the transparency gradation value or display gradation value priority adjusting the transparency gradation value without changing the display gradation value when the displayable range determination unit determines that the total value is greater than 1.

### Advantageous Effects of Invention

According to the first aspect described above, even when the image specified by the display gradation value and the transparency gradation value included in the image information signal is not within the displayable range, the display gradation value and the transparency gradation value can be adjusted by prioritizing the transparency gradation value or prioritizing the display gradation value. In this way, the display device can display the image, make the background transparent, and display the image and the background overlapping each other regardless of whether the image specified by the display gradation value and the transparency gradation value is within the displayable range.

According to the second aspect described above, even when the image specified by the display gradation value and the transparency gradation value is not within the displayable range, the display device can display only the background by adjusting the selection ratio and the transmittance according to the transparency gradation value priority.

According to the third aspect described above, even when the image specified by the display gradation value and the transparency gradation value is not within the displayable range, the display device can display the image and the background by adjusting the selection ratio and the transmittance according to the display gradation value priority.

According to the fourth aspect described above, when the image specified by the display gradation value and the transparency gradation value is within the displayable range, the selection ratio and the transmittance are the same in a case where the display gradation value and the transparency gradation value are the same in both cases of the transparency gradation value priority and the display gradation value priority. In this way, the display device can similarly display the image in the both cases.

According to the fifth aspect described above, the light source light is the monochromatic light, and even when the image specified by the display gradation value and the transparency gradation value is not within the displayable range, the liquid crystal display device can display a monochrome image.

According to the sixth aspect described above, the display light-emitting light source is configured to emit the light source light in a plurality of colors one after another in time division manner for respective fields. Thus, even when the image specified by the display gradation value and the transparency gradation value is not within the displayable range, the liquid crystal display device can display a color image.

According to the seventh aspect described above, occurrence of color breakup can be suppressed when an observer moves his/her line of sight at high speed, by further adding the color mixture field in which the light source light in at least two or more colors from a plurality of colors is emitted simultaneously.

According to the eighth aspect described above, the transparency gradation value included in the image information signal is a binary value being “0” or “1”. Thus, capacity of the signal including the transparency gradation value can be reduced. This can reduce the size of the drive control circuit unit that performs signal processing on the image information signal. Thus, manufacturing costs of the display device can be reduced.

According to the ninth aspect described above, both of the selection ratio adjustment panel and the transmittance adjustment panel include the liquid crystal panel and the absorption polarizing plate adhering to the front surface. Thus, the polarization direction of the light source light and the background light can be easily adjusted.

According to the tenth aspect described above, the light source light and the background light having the polarization directions orthogonal to each other can enter the first liquid crystal panel by the radiation plate. In this way, the display device allows transmission of only the light source light to display an image, allows transmission of only the background light to display only a background, and allows transmission of the light source light and the background light to display an image and a background overlapping each other, which can be easily achieved.

According to the eleventh aspect described above, the similar effects as those in the first aspect described above can be achieved.

### BRIEF DESCRIPTION OF DRAWINGS

FIG. 1 is a diagram illustrating a configuration of a display unit of a liquid crystal display device that includes only one liquid crystal panel and enables a transparent display.

FIG. 2 is a diagram illustrating transmission characteristics of the liquid crystal display device that includes only one liquid crystal panel illustrated in FIG. 1.

FIG. 3 is a block diagram illustrating a configuration of a liquid crystal display device according to a first embodiment of the present invention.

FIG. 4 is a cross-sectional view illustrating a configuration of a display unit included in the liquid crystal display device illustrated in FIG. 3.

FIG. 5 is a diagram illustrating a configuration of a backlight light source included in the liquid crystal display device illustrated in FIG. 3.

FIG. 6 is a diagram illustrating a change in polarization states of light source light and background light in a case where only the light source light is transmitted through the liquid crystal display device illustrated in FIG. 4.

FIG. 7 is a diagram illustrating a change in polarization states of the light source light and the background light in a case where only the background light is transmitted through the liquid crystal display device illustrated in FIG. 4.

FIG. 8 is a diagram illustrating transmission characteristics of the liquid crystal display device that includes two liquid crystal panels illustrated in 4.

FIG. 9 is a diagram illustrating a method for adjusting the liquid crystal display device when a pixel indicated by a display gradation value and a transparency gradation value included in an image information signal is not within a displayable range.

FIG. 10 is a diagram illustrating the display gradation value and the transparency gradation value for each pixel included in the image information signal used in the first embodiment.

FIG. 11 is a flowchart illustrating procedure for obtaining a selection ratio and a transmittance in a case of transparency gradation value priority in the first embodiment.

FIG. 12 is a diagram illustrating transmission states of the light source light and the background light when the display gradation value and the transparency gradation value are adjusted according to the transparency gradation value priority in the first embodiment.

FIG. 13 is a flowchart illustrating procedure for obtaining a selection ratio and a transmittance in a case of display gradation value priority in the first embodiment.

FIG. 14 is a diagram illustrating transmission states of the light source light and the background light when the display gradation value and the transparency gradation value are adjusted according to the display gradation value priority in the first embodiment.

FIG. 15 is a diagram illustrating a configuration of a backlight light source according to a modification of the backlight light source illustrated in FIG. 5.

FIG. 16 is a diagram illustrating display gradation values and a transparency gradation value for each pixel included in an image information signal used in a second embodiment.

FIG. 17 is a flowchart illustrating procedure for obtaining selection ratios and a transmittance in a case of transparency gradation value priority in the second embodiment.

FIG. 18 is a flowchart illustrating procedure for obtaining the selection ratios and the transmittance in the case of the transparency gradation value priority in the second embodiment, which continues from FIG. 17.

FIG. 19 is a block diagram illustrating a configuration of an image information signal conversion circuit included in a drive control circuit unit of the liquid crystal display device according to the second embodiment.

FIG. 20 is a diagram illustrating transmission states of the light source light and the background light when the display gradation value and the transparency gradation value are adjusted according to the transparency gradation value priority in the second embodiment.

FIG. 21 is a flowchart illustrating procedure for obtaining selection ratios and transmittances in a case of display gradation value priority in the second embodiment.

FIG. 22 is a flowchart illustrating procedure for obtaining the selection ratios and the transmittances in the case of the display gradation value priority in the second embodiment, which continues from FIG. 21.

FIG. 23 is a diagram illustrating transmission states of the light source light and the background light when the display gradation value and the transparency gradation value are adjusted according to the display gradation value priority in the second embodiment.

FIG. 24 is a flowchart illustrating procedure for obtaining a selection ratio and a transmittance in a case of transparency gradation value priority in a third embodiment.

FIG. 25 is a flowchart illustrating procedure for obtaining the selection ratio and the transmittance in the case of the transparency gradation value priority in the third embodiment, which continues from FIG. 24.

FIG. 26 is a diagram for describing a display gradation value and a transparency gradation value included in an image information signal used in the third embodiment.

FIG. 27 is a diagram illustrating transmission states of the light source light and the background light when the display gradation value and the transparency gradation value are adjusted according to the transparency gradation value priority in the third embodiment.

FIG. 28 is a flowchart illustrating procedure for obtaining a selection ratio and a transmittance in a case of display gradation value priority in the third embodiment.

FIG. 29 is a flowchart illustrating procedure for obtaining the selection ratio and the transmittance in the case of the display gradation value priority in the third embodiment, which continues from FIG. 28.

FIG. 30 is a diagram illustrating transmission states of the light source light and the background light when the display gradation value and the transparency gradation value are adjusted according to the display gradation value priority in the third embodiment.

FIG. 31 is a diagram illustrating transmission states of the light source light and the background light when a display gradation value and a transparency gradation value are adjusted according to transparency gradation value priority in a fourth embodiment.

FIG. 32 is a diagram illustrating transmission states of the light source light and the background light when the display gradation value and the transparency gradation value are adjusted according to display gradation value priority in the fourth embodiment.

FIG. 33 is a diagram illustrating a configuration of a display unit included in a liquid crystal display device according to a first modification, which can be used in the present invention.

FIG. 34 is a diagram illustrating a configuration of a display unit included in a liquid crystal display device according to a second modification, which can be used in the present invention.

FIG. 35 is a diagram illustrating a configuration of a display unit included in a liquid crystal display device according to a third modification, which can be used in the present invention.

### DESCRIPTION OF EMBODIMENT

### 1. Basic Study

A liquid crystal display device according to each embodiment of the present invention is a display device that includes two liquid crystal panels and enables a transparent display. Prior to its description, however, transmission characteristics of a liquid crystal display device 80 that includes only one liquid crystal panel and enables a transparent display are described.

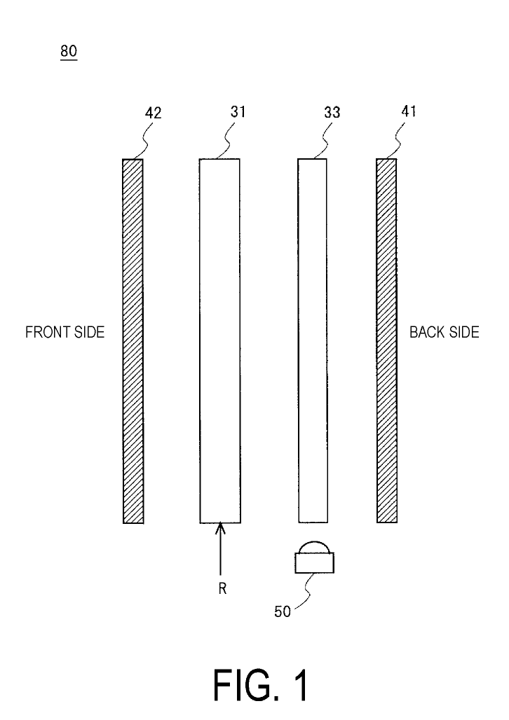

FIG. 1 is a diagram illustrating a configuration of a display unit of the liquid crystal display device 80 that includes only one liquid crystal panel and enables a transparent display. As illustrated in FIG. 1, an absorption polarizing plate 42, a liquid crystal panel 31, a light guide plate 33 including a backlight light source 50, and a reflection polarizing plate 41 are disposed in the order from the front side in the liquid crystal display device 80. The polarizing plate 33 emits light source light from the backlight light source 50 toward the back side. Polarization components of the light source light in the same polarization direction as a reflection axis of the reflection polarizing plate 41 are reflected and radiated on the back of the liquid crystal panel 31. Furthermore, polarization components of background light, which enters the reflection polarizing plate 41 from the back side, in the same polarization direction as a transmission axis of the reflection polarizing plate 41 enter the liquid crystal panel 31. Thus, the light source light and the background light that enter the liquid crystal panel 31 from the back side differ 90 degrees in the polarization direction.

The liquid crystal panel 31 selects the background light that enters from the back side and the light source light emitted from the backlight light source 50 for each pixel based on a transparency gradation value included in an image information signal, and allows the light to be transmitted therethrough to the front side. In this way, the liquid crystal display device 80 can display only an image, display only a background, and display an image and a background overlapping each other by adjusting a selection ratio of the light source light and the background light by the liquid crystal panel 31.

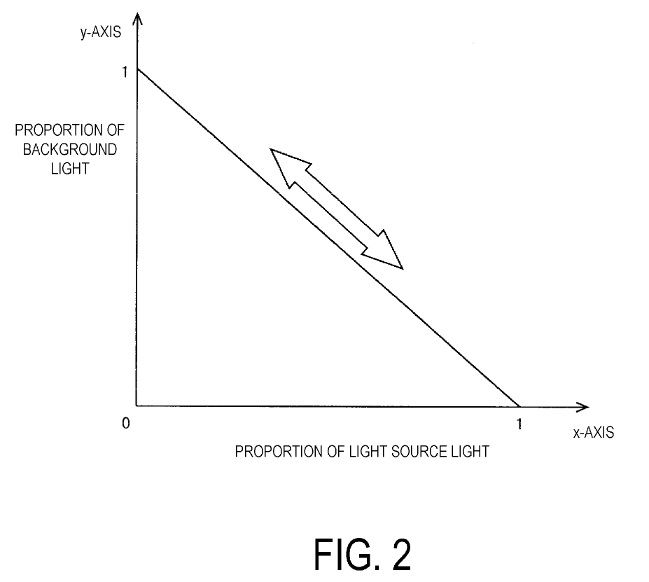

FIG. 2 is a diagram illustrating transmission characteristics of the liquid crystal display device 80 illustrated in FIG. 1. In the liquid crystal display device 80, a proportion of the light source light and a proportion of the background light that are transmitted through pixels of the liquid crystal panel 31 can only take on values on an oblique line illustrated by a thick line in FIG. 2. Thus, a decrease in the transmission proportion of the light source light increases the transmission proportion of the background light. Only the background light is transmitted on the y-axis, so that only a background is displayed. On the other hand, an increase in the transmission proportion of the light source light decreases the transmission proportion of the background light. Only the light source light is transmitted on the x-axis, so that only an image is displayed.

### 2. First Embodiment

### 2.1 Configuration of Liquid Crystal Display Device

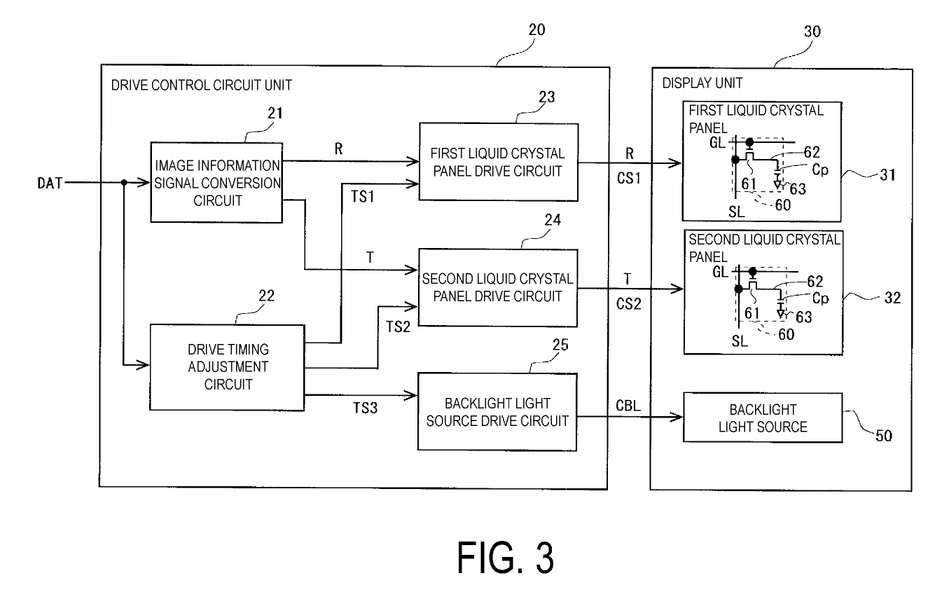

FIG. 3 is a block diagram illustrating a configuration of a liquid crystal display device according to a first embodiment of the present invention. As illustrated in FIG. 3, a liquid crystal display device (also referred to as a “display device”) 10 is a display device that includes a drive control circuit unit 20 and a display unit 30, displays a monochrome image, and enables a transparent display. The drive control circuit unit 20 includes an image information signal conversion circuit 21, a drive timing adjustment circuit 22, a first liquid crystal panel drive circuit 23, a second liquid crystal panel drive circuit 24, and a backlight light source drive circuit 25. The display unit 30 includes a first liquid crystal panel 31, a second liquid crystal panel 32, and a backlight light source (also referred to as a “display light-emitting light source”) 50 that emits white light. Note that an absorption polarizing plate (not illustrated) adheres to a front surface of each of the first liquid crystal panel 31 and the second liquid crystal panel 32, as described below.

The image information signal conversion circuit 21 is connected to the first liquid crystal panel drive circuit 23 and the second liquid crystal panel drive circuit 24. The drive timing adjustment circuit 22 is connected to the first liquid crystal panel drive circuit 23, the second liquid crystal panel drive circuit 24, and the backlight light source drive circuit 25. The first liquid crystal panel drive circuit 23 is connected to the first liquid crystal panel 31. The second liquid crystal panel drive circuit 24 is connected to the second liquid crystal panel 32. The backlight light source drive circuit 25 is connected to the backlight light source 50. Note that both of the first and second liquid crystal panel drive circuits 23, 24 include a scanning signal line drive circuit (not illustrated) that drives a scanning signal line GL formed on the liquid crystal panel described below and a data signal line drive circuit (not illustrated) that drives a data signal line SL.

An image information signal DAT including a display gradation value that corresponds to a gradation of an image and a transparency gradation value that indicates transparency of the image is provided to the image information signal conversion circuit 21 and the drive timing adjustment circuit 22 from the outside. The drive timing adjustment circuit 22 generates timing control signals TS1, TS2, TS3 for driving the first liquid crystal panel drive circuit 23, the second liquid crystal panel drive circuit 24, and the backlight light source drive circuit 25, respectively, based on the image information signal DAT. The drive timing adjustment circuit 22 provides the timing control signals TS1, TS2, TS3 to the first liquid crystal panel drive circuit 23, the second liquid crystal panel drive circuit 24, and the backlight light source drive circuit 25, respectively.

Based on the reception of the image information signal DAT, the image information signal conversion circuit 21 obtains a selection ratio R that determines selection proportions of light source light emitted from the backlight light source 50 and background light entering from the back side of the liquid crystal display device based on the transparency gradation value included in the image information signal DAT. The image information signal conversion circuit 21 provides the selection ratio R to the first liquid crystal panel drive circuit 23. The image information signal conversion circuit 21 obtains a transmittance T based on the display gradation value and the transparency gradation value to display gradations of an image and a background corresponding to the display gradation value included in the image information signal DAT. The image information signal conversion circuit 21 provides the transmittance T to the second liquid crystal panel drive circuit 24.

The first liquid crystal panel drive circuit 23 drives the first liquid crystal panel 31 based on the timing control signal TS1, selects the light source light and the background light in the proportions determined by the selection ratio R for each pixel, and allows the light source light and the background light to be transmitted. The second liquid crystal panel drive circuit 24 drives the second liquid crystal panel 32 based on the timing control signal TS2 and allows the light source light and the background light to be transmitted according to the transmittance T for each pixel. The backlight light source drive circuit 25 generates a light source control signal CBL based on the timing control signal TS3 and provides the light source control signal CBL to the backlight light source 50. In this way, the backlight light source 50 emits the light source light in color specified by the image information signal DAT at proper timing according to drive states of the first and second liquid crystal panels 31, 32.

The liquid crystal panel 31 (and the absorption polarizing plate adhering to its front surface) selects the light source light emitted from the backlight light source 50 and the background light entering from the back side of the liquid crystal display device in the proportions determined by the selection ratio R, and allow the light source light and the background light to be transmitted. The second liquid crystal panel 32 (and the absorption polarizing plate adhering to its front surface) allow the light source light and the background light to be transmitted in the proportions determined by the transmittance T. In this way, the liquid crystal display device can display an image, or a background, and display an image and a background overlapping each other by the light source light and the background light transmitted through the second liquid crystal panel 32.

Configurations of the first and second liquid crystal panels 31, 32 are described. The first and second liquid crystal panels 31, 32 each include a plurality of pixels 60. As illustrated in FIG. 3, each of the pixels 60 includes a thin film transistor (hereinafter referred to as a “TFT”) 61, a pixel electrode 62, a common electrode 63. and a pixel capacitance Cp. The TFT 61 operates as a switching element in which a gate terminal is connected to a scanning signal line GL and a source terminal is connected to a corresponding data signal line SL. The pixel electrode 62 is connected to a drain terminal of the TFT 61. The common electrode 63 is provided commonly to the plurality of pixels 60. The pixel capacitance Cp is sandwiched between the pixel electrode 62 and the common electrode 63 and is formed of a liquid crystal layer (not illustrated) provided commonly to the plurality of pixels 60. A signal voltage according to the display gradation value included in the image information signal DAT is charged in the pixel capacitance Cp. An alignment direction of liquid crystal molecules of the liquid crystal layer in the pixel capacitance Cp is rotated. In this way, a polarization direction of the light transmitted through the pixels 60 is rotated, and the selection ratio R and the transmittance T of the light source light are controlled. Note that FIG. 3 illustrates only one pixel 60 on each of the first and second liquid crystal panels 31, 32 for the sake of convenience, but the plurality of pixels 60 are actually formed in matrix thereon.

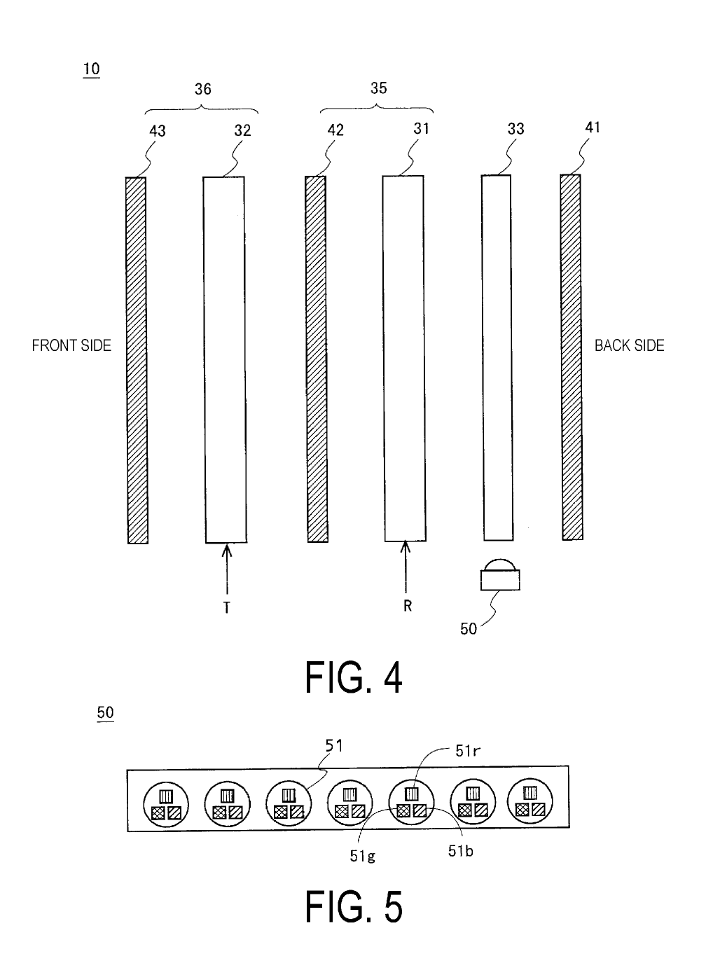

FIG. 4 is a cross-sectional view illustrating a configuration of the display unit included in the liquid crystal display device according to the present embodiment. As illustrated in FIG, 4, in the liquid crystal display device, a reflection polarizing plate 41, a light guide plate 33, the first liquid crystal panel 31, a first absorption polarizing plate 42, the second liquid crystal panel 32, and a second absorption polarizing plate 43 are disposed in parallel to each other in the stated order from the back side to the front side. When the selection ratio R obtained by the image information signal conversion circuit 21 based on the image information signal DAT is provided to the first liquid crystal panel 31 via the first liquid crystal panel drive circuit 23, the first liquid crystal panel 31 and the first absorption polarizing plate 42 allow the light source light and the background light to be transmitted in the proportions determined by the selection ratio R. When the transmittance T obtained by the image information signal conversion circuit 21 is provided to the second liquid crystal panel 32 via the second liquid crystal panel drive circuit 24, the second liquid crystal panel 32 and the second absorption polarizing plate 43 allow the light source light to be transmitted at a transmittance determined by the transmittance T and also allow the background light to be transmitted at the same transmittance. Accordingly, in the following description, the first liquid crystal panel 31 and the first absorption polarizing plate 42 may be collectively referred to as a “selection ratio adjustment panel 35”, the second liquid crystal panel 32 and the second absorption polarizing plate 43 may be collectively referred to as a “transmittance adjustment panel 36”, and the reflection polarizing plate 41 may be referred to as a “radiation plate”. Note that methods for obtaining the selection ratio R and the transmittance T are described below.

FIG. 5 is a diagram illustrating a configuration of the backlight light source 50. The backlight light source 50 is mounted on an end portion of the light guide plate 33. As illustrated in FIG. 5, the backlight light source 50 includes a plurality of lamps (also referred to as “light-emitting devices”) 51 arranged in a straight line. Each of the lamps 51 includes, for example, one red LED (light-emitting device) 51r that emits red light, one green LED 51g that emits green light, and one blue LED 51b that emits blue light. The backlight light source 50 simultaneously lights these LEDs 51r, 51g, 51b to emit white light to display a monochrome image in the liquid crystal display device 10.

In the following description, it is described that a transmission axis of the reflection polarizing plate 41 and transmission axes of the first and second absorption polarizing plates 42, 43 are adjusted to be orthogonal to each other so as to allow light in which a polarization direction is rotated 90 degrees by liquid crystals to be transmitted through the liquid crystal panels. Note that the transmission axis of the reflection polarizing plate 41 and the transmission axes of the first and second absorption polarizing plates 42, 43 may be adjusted to be parallel to each other so as to allow light in which a polarization direction is not rotated by liquid crystals to be transmitted through the liquid crystal panels.

### 2.2 Operation Principle of Liquid Crystal Display Device

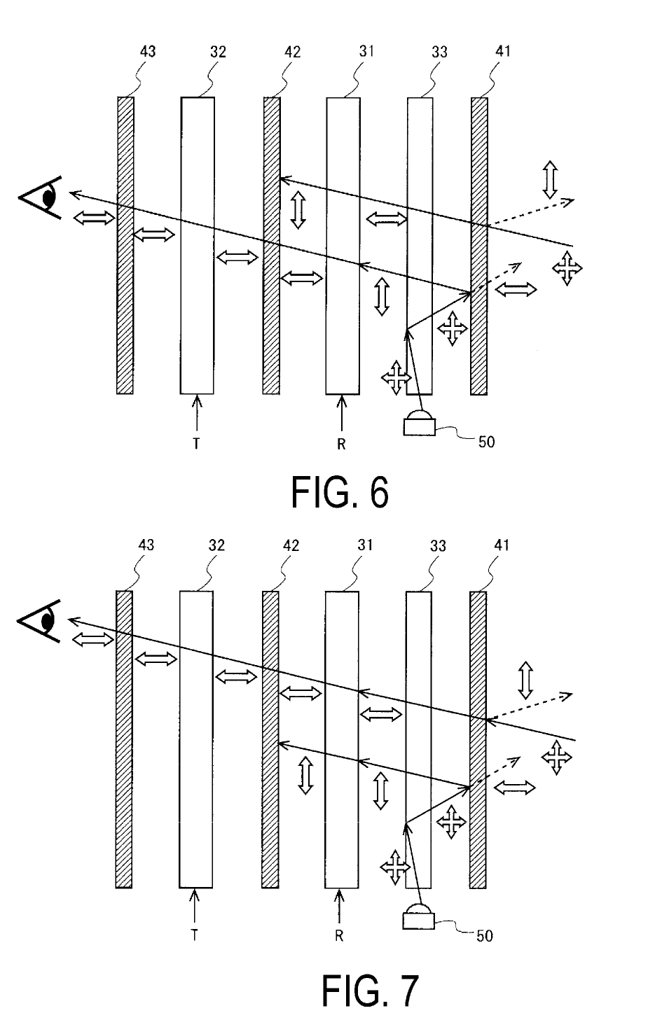

FIG. 6 is a diagram illustrating a change in polarization states of the light source light and the background light in a case where only the light source light is transmitted in the liquid crystal display device illustrated in FIG. 4. FIG. 7 is a diagram illustrating a change in polarization states of the light source light and the background light in a case where only the background light is transmitted in the liquid crystal display device illustrated in FIG. 4. Note that FIGS. 6 and 7 indicate a first polarization component by an arrow in the horizontal direction and a second polarization component by an arrow in the vertical direction. It is assumed that a direction of each of the transmission axes of the reflection polarizing plate 41 and the first and second absorption polarizing plates 42, 43 is parallel to a direction of a transmission axis of the first polarization component. This specification is described on assumption that the liquid crystals used in the liquid crystal display device are Twisted Nematic (TN) type, but they may be Vertical Alignment (VA) type. When the first and second liquid crystal panels 31, 32 are in an ON state, the first polarization component is converted into the second polarization component, and the second polarization component is converted into the first polarization component.

First, with reference to FIG. 6, a case where the light source light emitted from the backlight light source 50 is transmitted to the front side of the liquid crystal display device is described. When the light source light including the first and second polarization components of which polarization directions are orthogonal to each other enter the light guide plate 33 from the backlight light source 50, the light source light travels upward while being totally reflected on a surface of the light guide plate 33 in the light guide plate 33. At this time, the light source light that enters a scatterer (not illustrated) formed on the surface on the front side of the light guide plate 33 is reflected and emitted from the back of the light guide plate 33 toward the reflection polarizing plate 41. Of the first and second polarization components included in the light source light, the first polarization component parallel to the transmission axis of the reflection polarizing plate 41 is transmitted through the reflection polarizing plate 41 to the back side of the liquid crystal display device, and the second polarization component vertical to the transmission axis of the reflection polarizing plate 41 is reflected by the reflection polarizing plate 41, is transmitted through the light guide plate 33, and enters the first liquid crystal panel 31. On the other hand, of the first and second polarization components included in the background light that enters from the back side, the first polarization component parallel to the direction of the transmission axis of the reflection polarizing plate 41 is transmitted through the reflection polarizing plate 41 and the light guide plate 33 and enters the first liquid crystal panel 31. Thus, the polarization direction of the second polarization component in the light source light entering the first liquid crystal panel 31 and the polarization direction of the first polarization component in the background light are orthogonal to each other.

The first liquid crystal panel 31 is in the ON state, so that the polarization direction of the polarization component in each of the light source light and the background light is rotated. As a result, the second polarization component in the light source light is converted into the first polarization component, and the first polarization component in the background light is converted into the second polarization component. Then, each of the converted component is emitted from the first liquid crystal panel 31. The transmission axis of the first absorption polarizing plate 42 is parallel to the polarization direction of the first polarization component, so that the first polarization component in the light source light is transmitted through the first absorption polarizing plate 42 and enters the second liquid crystal panel 32. However, the second polarization component in the background light orthogonal to the direction of the transmission axis is absorbed by the first absorption polarizing plate 42, so that the second polarization component in the background light cannot be transmitted through the first absorption polarizing plate 42.

The second liquid crystal panel 32 is in an OFF state, so that the first polarization component in the light source light is transmitted through the second liquid crystal panel 32 without rotating the polarization direction of the first polarization component. The transmission axis of the second absorption polarizing plate 43 is parallel to the polarization direction of the first polarization component, so that the first polarization component in the light source light is further transmitted through the second absorption polarizing plate 43 and reaches the front side. As a result, an observer in front of the liquid crystal display device can visually recognize only an image.

Next, with reference to FIG. 7, a case where the background is transmitted to the front side of the liquid crystal display device is described. The description of the light source light and the background light until they enter the first liquid crystal panel 31 is the same as that in the case illustrated in FIG. 6, so that the description will be omitted. The first liquid crystal panel 31 is in the OFF state unlike the case illustrated in FIG. 6, so that the polarization component in each of the light source light and the background light is transmitted without rotating the polarization direction of the polarization component. As a result, the second polarization component in the light source light and the first polarization component in the background light are emitted from the first liquid crystal panel 31. The transmission axis of the first absorption polarizing plate 42 is parallel to the polarization direction of the first polarization component, so that the second polarization component in the light source light orthogonal to the direction of the transmission axis is absorbed by the first absorption polarizing plate 42. Thus, the second polarization component cannot be transmitted through the first absorption polarizing plate 42. However, the first polarization component in the background light is parallel to the direction of the transmission axis of the first absorption polarizing plate 42, so that the first polarization component in the background tight is transmitted through the first absorption polarizing plate 42.

The second liquid crystal panel 32 is in the OFF state, so that the first polarization component in the background light is transmitted through the second liquid crystal panel 32 without rotating the polarization direction of the first polarization component. The transmission axis of the second absorption polarizing plate 43 is parallel to the polarization direction of the first polarization component, so that the first polarization component in the background light is further transmitted through the second absorption polarizing plate 43 and is provided the front side. As a result, an observer in front of the liquid crystal display device can visually recognize only a background.

Note that, when a voltage applied to the first liquid crystal panel 31 is an intermediate voltage between that in the case of FIG. 6 and that in the case of FIG. 7, the light source light and the background light include the first polarization component and the second polarization component in proportions according to the applied voltage. Thus, the first polarization component in the tight source light and the background light is transmitted to the front side. In this way, an observer in front of the liquid crystal display device can visually recognize a displayed image overlapping a background.

### 2.3 Transmission Characteristics of Liquid Crystal Display Device

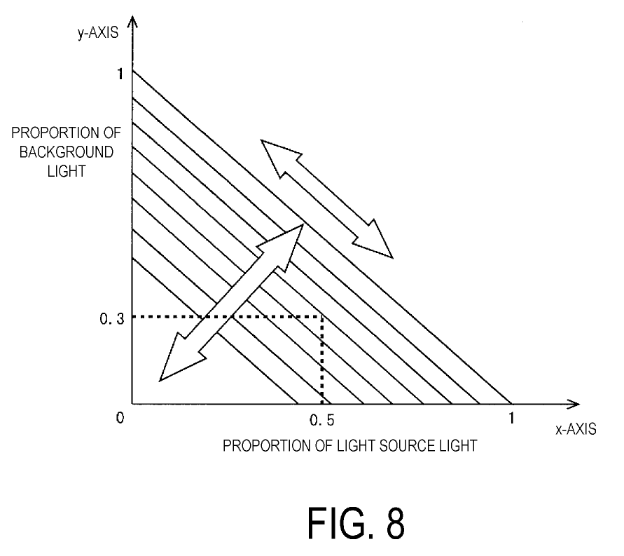

FIG. 8 is a diagram illustrating transmission characteristics of the liquid crystal display device 10. As described above, in the liquid crystal display device 10, the first liquid crystal panel 31 adjusts the selection ratio of the light source light and the background light. The second liquid crystal panel 32 then adjusts the proportions of the light source light and the background light that are emitted from the first liquid crystal panel 31 and transmitted to the front side to display gradations of each of an image and a background. In FIG. 8, the proportions of the light source light and the background light transmitted through the first liquid crystal panel 31 are determined by a position on an oblique line similarly to the case illustrated in FIG. 2. For the light source light and the background light selected by the first liquid crystal panel 31, the second liquid crystal panel 32 determines transmission proportions of the selected light source light and background light to be transmitted to the front side. The determination of the transmission proportions by the second liquid crystal panel 32 corresponds to parallel translation of the oblique line in a direction closer to the origin while maintaining a slope at constant and parallel translation in a direction away from the origin, as indicated by arrows in FIG. 8.

In this way, the first liquid crystal panel 31 adjusts the selection ratio indicating the selection proportions of the light source light and the background light, and the second liquid crystal panel 32 adjusts the transmission proportions of the selected light source light and background light to the front side. Accordingly, the proportion of the light source light and the proportion of the background light are respectively indicated by an x-coordinate and a y-coordinate of points inside a triangle surrounded by the x-axis, the y-axis, and the oblique tine in FIG. 8. As seen from FIG. 8, a total value of the proportion of the light source tight and the proportion of the background light is less than or equal to 1. For example, coordinates in a position illustrated in FIG. 8 are (0.5, 0.3). Thus, the proportion of the light source light transmitted to the front side is 0.5, and the proportion of the background tight is 0.3. Note that remaining 0.2 indicates a proportion of non-transmission that does not allow the light source light and the background light to be transmitted.

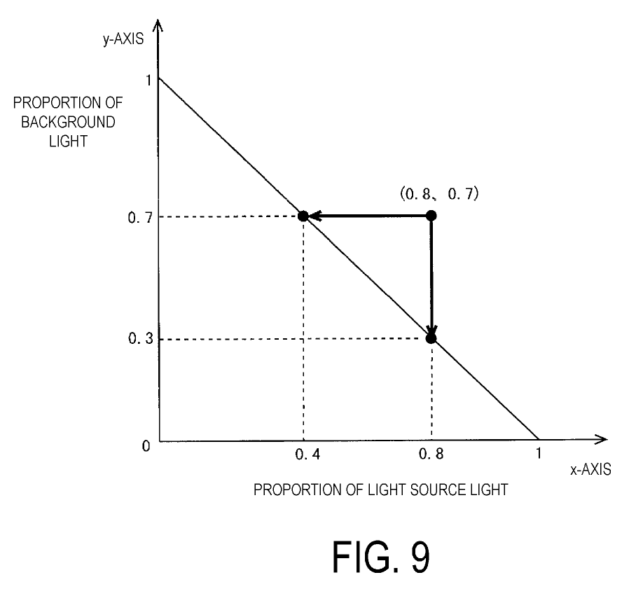

FIG. 9 is a diagram illustrating a method for adjusting the liquid crystal display device 10 when a display state of a pixel indicated by the display gradation value and the transparency gradation value included in the image information signal DAT is not within a displayable range. The proportion of the light source light illustrated in FIG. 9 is substantially equal to the display gradation value. The proportion of the background light illustrated in FIG. 9 is substantially equal to the transparency gradation value. Then, a case where the display gradation value is 0.8 and the transparency gradation value is 0.7 is described with reference to FIG. 9. In this case, a total value of the proportion of the light source light and the proportion of the background light is greater than 1, so that a pixel indicated by them is not included inside the triangle illustrated in FIG. 9, in other words, is not within the displayable range. Thus, the liquid crystal display device 10 cannot display the pixel indicated by these display gradation value and transparency gradation value.

To display such a pixel, the display gradation value or the transparency gradation value needs to be adjusted. For a method for adjusting the display gradation value, while the transparency gradation value is maintained at a constant value, the display gradation value is moved to a position on the oblique line in parallel to the x-axis in a direction in which the transmission proportion of the light source light decreases. In other words, the method for adjusting the display gradation value reduces the proportion of the light source light to the position on the oblique line while maintaining the proportion of the background light at constant. Accordingly, the proportion of the background light remains at 0.7, and the proportion of the light source light can be reduced to 0.4.

For a method for adjusting the transparency gradation value, while the display gradation value is maintained at a constant value, the transparency gradation value is moved to a position on the oblique line in parallel to the y-axis in a direction in which the transmission proportion of the background light decreases. In other words, the method for adjusting the transparency gradation value reduces the proportion of the background light to the position on the oblique line while maintaining the proportion of the light source light at constant. Accordingly, the proportion of the light source light remains at 0.8, and the proportion of the background light can be reduced to 0.3. In this way, the display gradation value and the transparency gradation value are moved to the displayable range by either of the adjustment methods, so that the liquid crystal display device 10 can display an image and a background adjusted based on the image information signal.

Of the two adjustment methods described above, the method for adjusting the display gradation value while maintaining the transparency gradation value at a constant value is referred to as “transparency gradation value priority”. The method for adjusting the transparency gradation value while maintaining the display gradation value at a constant value is referred to as “display gradation value priority”. In each of embodiments described below, the image and the background displayed when being adjusted according to the transparency gradation value priority and the display gradation value priority are described.

Note that, in the liquid crystal display device 10, the absorption polarizing plate 42 and the reflection polarizing plate 41 adheres to the front surface and the back surface, respectively, of the first liquid crystal panel 31 that determines the transmission proportions of the light source light and the background light. Thus, the light source light and the background light whose polarization directions are orthogonal to each other enter the first liquid crystal panel 31. Accordingly, by rotating their polarization directions, the first liquid crystal panel 31 can adjust a selection ratio of the light source light and the background light. However, a liquid crystal panel that includes a reflection polarizing plate adhering to the front surface thereof and an absorption polarizing plate adhering to the back surface thereof has a shutter function of allowing transmission of the background light and blocking the background light, but cannot adjust a selection ratio of the light source light and the background light. Thus, the present invention is not applicable to a liquid crystal display device in which such a liquid crystal panel is disposed instead of the first liquid crystal panel 31 even in a case where the liquid crystal display device includes two liquid crystal panels.

### 2.4 For Transparency Gradation Value Priority

### 2.4.1 How to Obtain Selection Ratio and Transparency

When a pixel indicated by the display gradation value and the transparent gradation value included in the image information signal provided from the outside is not within the displayable range, the liquid crystal display device has two adjustment methods. The two adjustment methods include the transparency gradation value priority that adjusts the display gradation value while maintaining the transparency gradation value at a constant value, and the display gradation value priority that adjusts the transparency gradation value while maintaining the display gradation value at a constant value. Methods for obtaining the selection ratio R and the transmittance T by these two methods are described one after another.

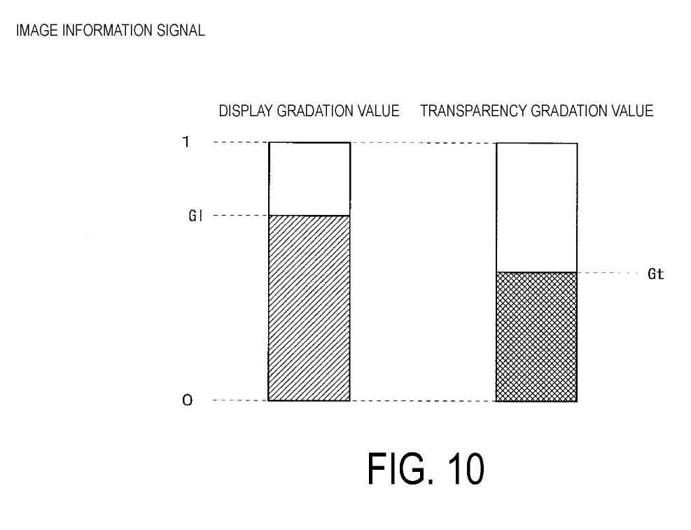

First, an adjustment according to the transparency gradation value priority is described. FIG. 10 is a diagram illustrating the display gradation value and the transparency gradation value for each pixel included in the image information signal. As illustrated in FIG. 10, a display gradation value Gl included in the image information signal is a value within a range of 0≤Gl≤1, and a transparency gradation value Gt is a value within a range of 0≤Gt≤1.

The selection ratio R indicates selection proportions of the light source light and the background light in the selection ratio adjustment panel 35. The selection ratio R is a value within a range of 0≤R≤1. The transmittance T indicates a transmission proportion of the light source light or the background light through the transmittance adjustment panel 36, the light source light or the background light having been transmitted through the selection ratio adjustment panel 35. The transmittance T is a value within a range of 0≤T≤1.

Relationships between each of the display gradation value Gl and the transparency gradation value Gt, and the selection ratio R and the transmittance T are expressed Equations (1) and (2) below.

Gl=Rx×T (1)

Gt=(1−R)×T (2)

R and T are respectively expressed Equations (3) and (4) below from Equations (1) and (2).

R=Gl/(Gl+Gt) (3)

T=Gl+Gt (4)

In this case, a proportion (non-transmission) Gn of the light source light and the background light that are absorbed by the selection ratio adjustment panel 35 or the transmittance adjustment panel 36 and cannot be transmitted are expressed Equation (5) below.

Gn=1−Gl−Gt (5)

The liquid crystal display device is configured to select the background light (substantially equal to the transparency gradation value) and the light source light (substantially equal to the display gradation value) by the selection ratio adjustment panel 35. Thus, Relationship (6) needs to be satisfied to display an image or a background.

Gl+Gt≤1 (6)

Accordingly, when Relationship (6) is not satisfied, in other words, when Gl+Gt>1, the transparency gradation value Gt is prioritized, and the display gradation value Gl is adjusted to be smaller. In a case where the display gradation value after the adjustment is expressed as Gl′, a relationship between the display gradation value Gl′ and the transparency gradation value Gt is expressed Equation (7) below. Equation (7) is included within the range of Relationship (6), so that an image or a background can be displayed.

Gl′+Gt=1 (7)

In this way, the selection ratio R and the transmittance T are expressed by Equation (8) and Equation (9) below, respectively, by using Gl′ as the display gradation value and also modifying Equations (3) and (4) with Equation (7).

R=Gl′/(Gl′+Gt)=1−Gt (8)

T=Gl′+Gt=1 (9)

In this case, the non-transmission Gn of the light source light and the background light that cannot be transmitted to the front side of the liquid crystal display device is expressed by Equation (10) below from Equation (5).

Gn=1−Gl′−Gt (10)

As described above, values of the selection ratio R and the transmittance T vary depending on whether (Gl+Gt) is less than or equal to 1. In other words, when Gl+Gt≤1, the selection ratio R and the transmittance T are expressed by Equation (3) and Equation (4), respectively. When Gl+Gt>1, the selection ratio R and the transmittance T are expressed by Equation (8) and Equation (9), respectively.

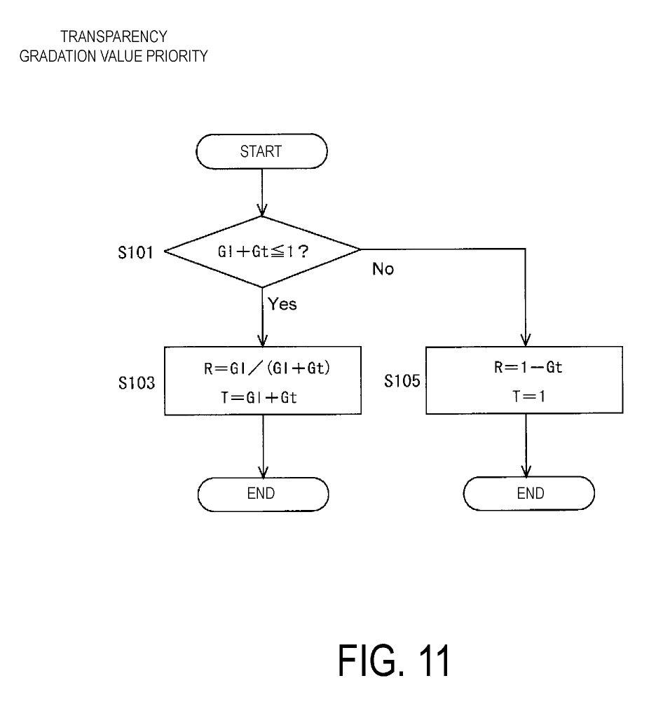

Next, procedure for obtaining the selection ratio R and the transmittance T is described with reference to a flowchart. FIG. 11 is a flowchart illustrating procedure for obtaining the selection ratio R and the transmittance T in the case of the transparency gradation value priority in the present embodiment.

As illustrated in FIG. 11, first, in Step S101, it is determined whether the display gradation value Gl and the transparency gradation value Gt satisfy Relationship (6) described above. As a result of the determination, in a case where it is determined that Relationship (6) is satisfied (in a case where it is determined YES), the processing proceeds to Step S103. In Step S103, the selection ratio R and the transmittance T are obtained by Equation (3) and Equation (4), respectively, and the processing is terminated.

As a result of the determination in Step S101, in a case where it is determined that Relationship (6) is not satisfied (in a case where it is determined NO), the processing proceeds to Step S105. In Step S105, the selection ratio R and the transmittance T are obtained by Equation (8) and Equation (9), respectively, and the processing is terminated. In this way, the selection ratio R and the transmittance T in the case of the transparency gradation value priority can be obtained regardless of whether (Gl+Gt) is less than or equal to 1.

### 2.4.2 Display State

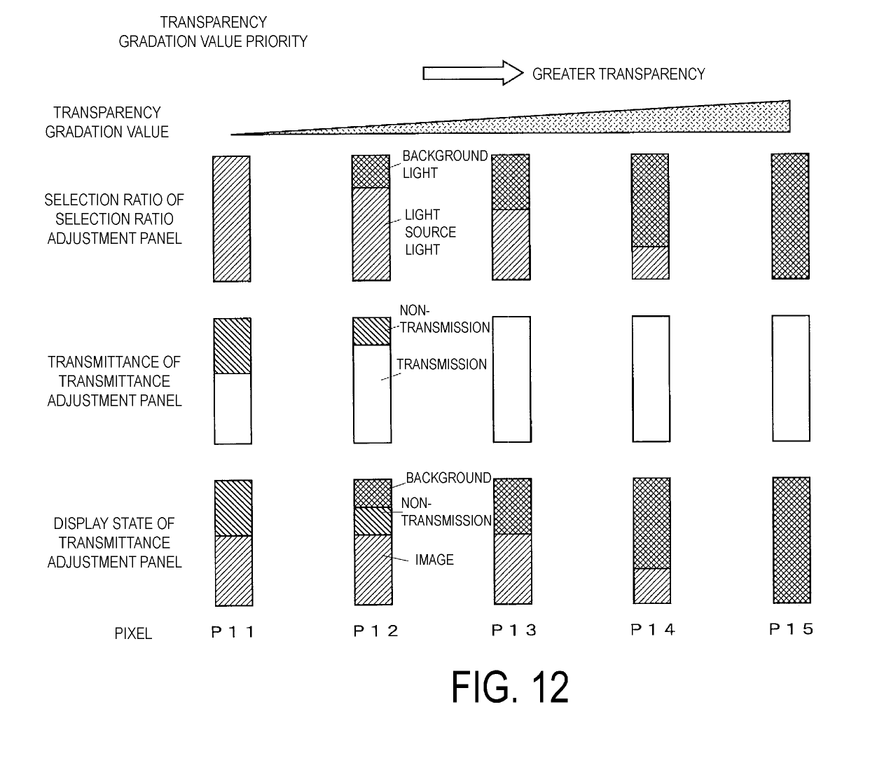

A change of an image or a background displayed when being adjusted according to the transparency gradation value priority as the transparency gradation value increases in a case where the light source light emitted from the backlight light source 50 is monochromatic light (for example, white light) is described. FIG. 12 is a diagram illustrating transmission states of the light source light and the background light when the display gradation value and the transparency gradation value are adjusted according to the transparency gradation value priority. In FIG. 12, as the transparency gradation value changes, a selection ratio of the selection ratio adjustment panel 35, a transmittance of the transmittance adjustment panel 36, and a display state of the transmittance adjustment panel 36 are illustrated by 5 stages that are states P11 to P15. Specifically, the transparency gradation value Gt changes in the order of “0”, “0.2”, “0.4”, “0.7”, and “1” from the state P11 to the state P15, respectively, while the display gradation value Gl is “0.6” in all the states. Hereinafter, the states P11 to P15 are described one after another. Note that an image displayed in this case is monochrome.

In the state P11, the display gradation value Gl is “0.6” and the transparency gradation value Gt is “0”. In Step S101, it is determined that (Gl+Gt) is less than or equal to “1”, and the processing proceeds to Step S103. The selection ratio R is 1 and the transmittance T is 0.6 from Equations (3) and (4) described above, respectively. Thus, the display gradation value Gl that indicates the image is “0.6” and the transparency gradation value Gt that indicates the background is “0” from Equations (1) and (2), respectively, and the non-transmission Gn is 0.4 from Equation (5). As a result, only the image is displayed.

In the state P12, the display gradation value Gl is “0.6” and the transparency gradation value Ct is “0.2”. In Step S101, it is determined that (Gl+Ct) is less than or equal to “1”, and the processing proceeds to Step S103. The selection ratio R is 0.75 and the transmittance T is 0.8 from Equations (3) and (4) described above, respectively. Thus, the display gradation value Gl that indicates the image is “0.6” and the transparency gradation value Gt that indicates the background is “0.2” from Equations (1) and (2), respectively, and the non-transmission Gn is 0.2 from Equation (5). As a result, the background is transparent while the image is displayed.

In the state P13, the display gradation value Gl is “0.6” and the transparency gradation value Gt is “0.4”. In Step S101, it is determined that (Gl+Gt) is “1”, and the processing proceeds to Step S103. The selection ratio R is “0.6” and the transmittance T is “1” from Equations (3) and (4) described above, respectively. Thus, the display gradation value Gl that indicates the image is “0.6” and the transparency gradation value Ct that indicates the background is “0.4” from Equations (1) and (2), respectively, and the non-transmission Gn is 0 from Equation (5). As a result, the background is transparent while the image is displayed.

In the state P14, the display gradation value Gl is “0.6” and the transparency gradation value Gt is “0.7”. In Step S101, it is determined that (Gl+Ct) is greater than “1”,and the processing proceeds to Step S105. The selection ratio R is “0.3” and the transmittance T is “1” from Equations (8) and (9), respectively. Thus, the display gradation value Gl that indicates the image is “0.3” and the transparency gradation value Ct that indicates the background is “0.7” from Equations (1) and (2), respectively, and the non-transmission Gn is 0 from Equation (10). As a result, the background is transparent while the image is displayed.

In the state P15, the display gradation value Gl is “0.6” and the transparency gradation value Gt is “1”. In Step S101, it is determined that (Gl+Gt) is greater than “1”, and the processing proceeds to Step S105. The selection ratio R is “0” and the transmittance T is “1” from Equations (8) and (9), respectively. Thus, the display gradation value Gl that indicates the image is “0” and the transparency gradation value Gt that indicates the background is “1” from Equations (1) and (2), respectively, and the non-transmission Gn is “0” from Equation (10). As a result, only the background is transparent.

### 2.5 For Display Gradation Value Priority

### 2.5.1 How to Obtain Selection Ratio and Transparency

Next, a case of the display gradation value priority is described. Also in the case of the display gradation value priority similar to the described case of the transparency gradation value priority, the display gradation value Gl included in the image information signal is a value within a range of 0≤Gl≤1, and the transparency gradation value (it is a value within a range of 0≤Gt≤1. The selection ratio R of the light source light and the background light of the selection ratio adjustment panel 35 is a value within a range of 0≤R≤1. The transmittance T of the light that has been transmitted through the selection ratio adjustment panel 35 and is to be transmitted through the transmittance adjustment panel 36 is a value within a range of 0≤T≤1.

Also in the case of the display gradation value priority similar to the case of the transparency gradation value priority, the liquid crystal display device needs to satisfy Relationship (6). In this case, the selection ratio R and the transmittance T are obtained from Equation (3) and Equation (4), respectively, and the non-transmission is obtained from Equation (5).

On the other hand, when Relationship (6) is not satisfied, in other words, when Gl+Gt>1, the display gradation value Gl is prioritized, and the transparency gradation value Gt is adjusted to be smaller. In a case where the transparency gradation value after the adjustment is expressed as Gt′, a relationship between the display gradation value Gl and the transparency gradation value Gt′ after the adjustment is expressed by Equation (11) below. The relationship is included within the range of Relationship (6), resulting in a displayable state.

Gl+Gt′=1 (11)

In this way, Equation (3) and Equation (4) are expressed by Equation (12) and Equation (13) below, respectively, by using the transparency gradation value Gt′ after the adjustment as the transparency gradation value and also modifying Equations (3) and (4) with Equation (11).

R=Gl/(Gl+Gt′)=Gl (12)

T=Gl+Gt′=1 (13)

In this case, the non-transmission Gn is expressed by Equation (14).

Gn=1−Gl−Gt′ (14)

As described above, values of the selection ratio R and the transmittance T vary depending on whether (Gl+Gt) is less than or equal to 1. In other words, when Gl+Gt≤1, the selection ratio R and the transmittance T are expressed by Equation (3) and Equation (4), respectively. When Gl+Gt>1, the selection ratio R and the transmittance T are expressed by Equation (12) and Equation (13), respectively.

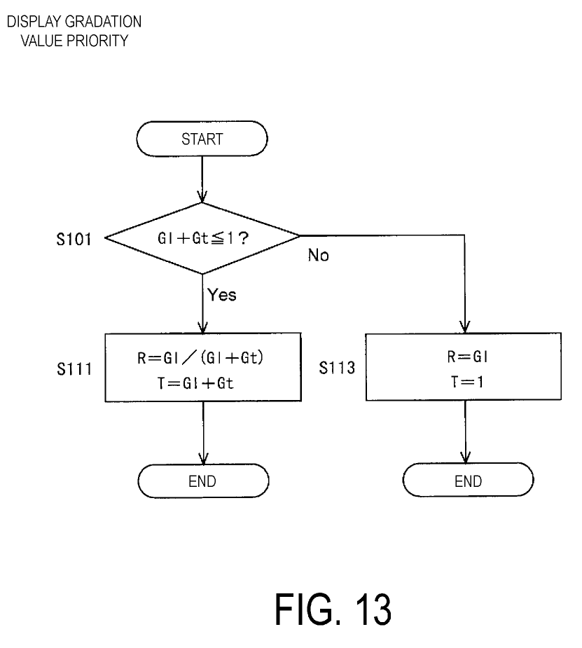

Next, procedure for obtaining the selection ratio R and the transmittance T is described with reference to a flowchart. FIG. 13 is a flowchart illustrating procedure for obtaining the selection ratio R and the transmittance T in the case of the display gradation value priority in the present embodiment. Note that the same steps illustrated in FIG. 13 as the steps illustrated in FIG. 11 are denoted by the same reference numerals.

As illustrated in FIG. 13, first, in Step S101, it is determined whether the display gradation value Gl and the transparency gradation value Gt satisfy

Relationship (6) described above. As a result of the determination, in a case where it is determined that above-described Relationship (6) is satisfied (in a case where it is determined YES), the processing proceeds to Step S111. In Step S111, the selection ratio R and the transmittance T are obtained by Equation (3) and Equation (4), respectively, and then the processing is terminated.

As a result of the determination in Step S101, in a case where it is determined that above-described Relationship (6) is not satisfied (in a case where it is determined NO), the processing proceeds to Step S113. In Step S113, the selection ratio R and the transmittance T are obtained by Equation (12) and Equation (13), respectively, and then the processing is terminated. In this way, the selection ratio R and the transmittance T can be obtained regardless of whether (Gl+Gt) is less than or equal to 1.

### 2.5.2 Display State

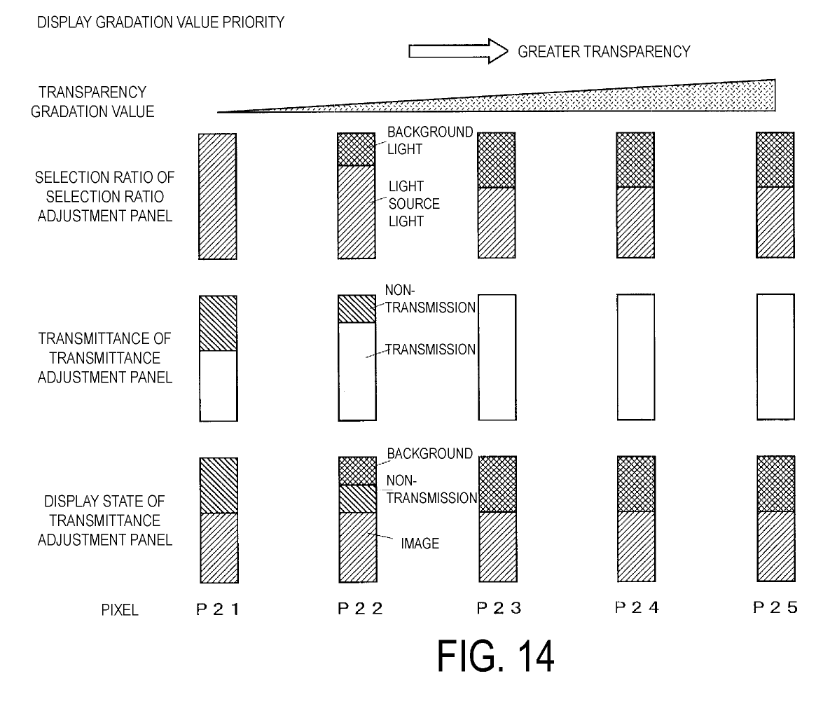

A change of an image or a background displayed when being adjusted according to the display gradation value priority as the transparency gradation value increases in a case where the light source light emitted from the backlight light source 50 is monochromatic light (for example, white light) is described. FIG. 14 is a diagram illustrating transmission states of the light source light and the background light when the display gradation value and the transparency gradation value are adjusted according to the display gradation value priority. In FIG. 14, as the transparency gradation value changes, a selection ratio of the selection ratio adjustment panel 35, a transmittance of the transmittance adjustment panel 36, and a display state of the transmittance adjustment panel 36 are illustrated by 5 stages that are states P21 to P25. Specifically, the transparency gradation value Gt changes in the order of “0”, “0.2”, “0.4”, “0.7”, and “1” from the state P21 to the state P25, respectively, while the display gradation value Gl is “0.6” in all the states. Hereinafter, the states P21 to P25 are described. Note that an image displayed in this case is monochrome.

The display gradation value Gl, the transparency gradation value Gt, and the non-transmission Gn in the states P21 to P23 are the same as those in the states P11 to P13 for the transparency gradation value priority, so that their description will be omitted.

In the state P24, the display gradation value Gl is “0.6” and the transparency gradation value Gt is “0.7”. In Step S101, it is determined that (Gl+Gt) is greater than “1”, and the processing proceeds to Step S113. The selection ratio R is “0.6” and the transmittance T is “1” from Equations (12) and (13), respectively. Thus, the display gradation value Gl is “0.6” and the transparency gradation value Gt is “0.4” from Equations (1) and (2), respectively, and the non-transmission Gn is 0 from Equation (15). As a result, the background is transparent while the image is displayed.

In the state P25, the display gradation value Gl is “0.6” and the transparency gradation value Gt is “1”. In Step S101, it is determined that (Gl+Gt) is greater than “1”, and the processing proceeds to Step S113. The selection ratio R is “0.6” and the transmittance T is “1” from Equations (12) and (13), respectively. Thus, the display gradation value Gl is “0.6” and the transparency gradation value is “0.4” from Equations (1) and (2), respectively, and the non-transmission Gn is 0 from Equation (15). As a result, the background is transparent while the image is displayed in contrast to the case of the transparency gradation value priority.

### 2.6 Effects

According to the present embodiment, even when an image specified by the display gradation value and the transparency gradation value included in the image information signal is not within a displayable range in the liquid crystal display device that displays a monochrome image, the display gradation value and the transparency gradation value can be adjusted by prioritizing the transparency gradation value or prioritizing the display gradation value. In this way, the liquid crystal display device can display a monochrome image, make a background transparent, and display a monochrome image and a background overlapping each other regardless of whether the image specified by the display gradation value and the transparency gradation value is within the displayable range.

### 2.7 Modification

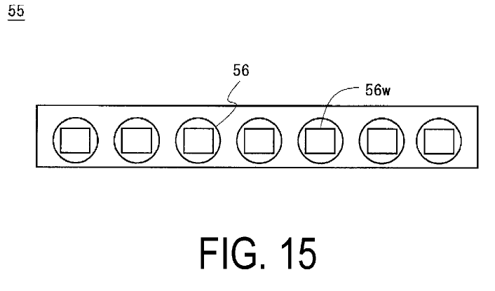

FIG. 15 is a diagram illustrating a configuration of a backlight light source 55 according to a modification of the backlight light source 50 illustrated in FIG. 5. As illustrated in FIG. 15, the backlight tight source 55 also includes a plurality of lamps (also referred to as “light-emitting devices”) 56 arranged in a straight line. However, one white LED 56w that emits white light is disposed in each of the lamps 56. Thus, the backlight light source 55 is mounted on the end portion of the light guide plate 33, and each of the white LEDs 56w is lighted to emit white light from each of the lamps 56 of the backlight light source 55. The liquid crystal display device 10 can then display a monochrome image.

### 3. Second Embodiment

A liquid crystal display device according to the present embodiment displays a color image by field sequential driving. Thus, a configuration of the liquid crystal display device is the same as the configuration of the liquid crystal display device 10 according to the first embodiment except for the method for driving the backlight light source 50.

The backlight light source 50 includes the plurality of lamps 51 arranged in a straight line as described in the first embodiment. Each of the lamps 51 includes, for example, one red LED (light emitting device) 51r that emits red light, one green LED 51g that emits green light, and one blue LED 51b that emits blue light. Thus, the backlight light source 50 lights the LEDs 51r, 51g, 51b in each of the colors one after another in time division manner at high speed to display a color image. In this way, the red light, the green light, and the blue light emitted from the backlight light source 50 are radiated one after another on the back of the first liquid crystal panel 31. The liquid crystal display device can thus display a color image.

### 3.1 For Transparency Gradation Value Priority

### 3.1.1 How to Obtain Selection Ratio and Transparency

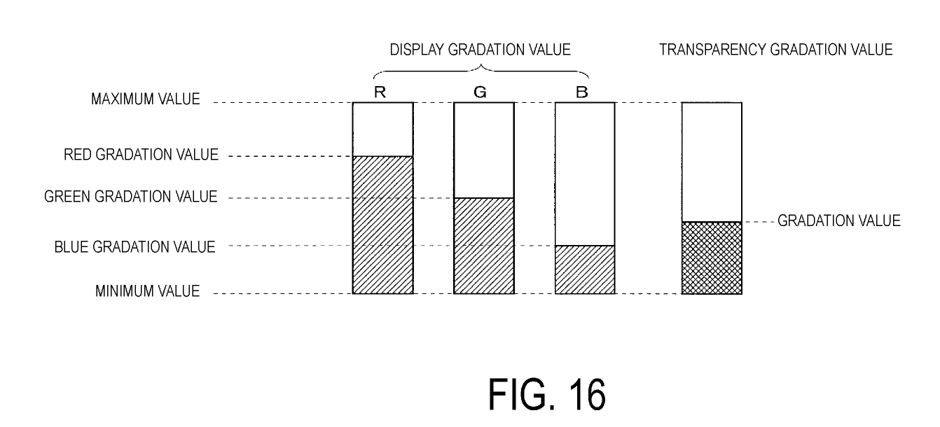

First, an adjustment according to the transparency gradation value priority is described. FIG. 16 is a diagram illustrating display gradation values and a transparency gradation value for each pixel included in an image information signal. As illustrated in FIG. 16, a transparency gradation value Gt included in the image information signal is a value within a range of 0≤Gt≤1. Display gradation values Gl0, Gl1, Gl2 in respective fields are values within a range of 0≤Gl0≤1, a range of 0≤Gl1≤1, and a range of 0≤Gl2≤1 , respectively. It is described in the following description on the assumption that the display gradation values Gl0, Gl1, Gl2 in the respective fields are display gradation values in a red field, a green field, and a blue field, respectively. However, their corresponding relationships are not fixed, and they may be display gradation values in fields in different colors.

An average value (display gradation average value) Gl of the display gradation values Gl1 to Gl2 in the respective fields is expressed by Equation (21) below.

Gl=(Gl0+Gl1+Gl2)/3 (21)

Also, in the present embodiment similar to the first embodiment, a selection ratio R is a value within a range of 0≤R≤1, and a transmittance T is a value within a range of 0≤T≤1.

Relationships between each of the display gradation average value Gl and the transparency gradation value Gt, and the selection ratio R and the transmittance T are expressed as follows. At this time, the transparency gradation value Gt is 1 when transparency in each of the fields is maximum, so that

Gl0=R0×T0 (22a)

Gl1=R1×T1 (22b)

Gl2=R2×T2 (22c)

Gt={(1−R0)×T0+(1−R1)×T1+(1−R2)×T3}/3 (23),

First, a case of Gl+Gt >1 is described. In this case, as described in the basic study, both of an image and a background cannot be displayed. Then, the transparency gradation value is prioritized to lead to a state in which the image and the background can be displayed. When the transparency gradation value is prioritized, a value of the display gradation average value Gl is adjusted to be smaller without changing a value of the transparency gradation value Gt and to be a display gradation average value Gl′ after the adjustment. Accordingly, it satisfies Gl′+Gt=1, resulting in the state in which the image and the background can be displayed.

An adjustment method according to the transparency gradation value priority is described below. Luminance is reduced while color balance is maintained. With display gradation values Gl0′, Gl1′, Gl2′ in the respective fields after the luminance is reduced and a ratio α (α<1) at which the luminance is reduced,

Gl0′=Gl0×α (24a)

Gl1′=Gl1×α (24b)

Gl2′=Gl2×α (24c).

On the other hand, it satisfies Gl′+Gt=1, so that

Gl′+Gt=(Gl0′+Gl1′+Gl2′)/3+Gt=1 (25).

When Equation (23) and Equations (24a) to (24c) are substituted into Equation (25),

T0+T1+T2=3 (26).

Since T1, T2, and T3 are 0≤T1≤1, 0≤T2≤1, and 0≤T3≤1, respectively, from Equation (26),

T0=T1=T2=1 (27).

When Equations (24a) to (24c) are substituted into Equation (25),

Gt+α/3×(Gl0+Gl1+Gl2)=1 (28).

When Equation (28) is solved for α,

α=3×(1−Gt)/(Gl0+Gl1+Gl2) (29).

When Equation (27) is substituted into Equations (22a) to (22c) and Gl0, Gl1, and Gl2 are replaced with Gl0′, Gl1′, and Gl2′, respectively,

R0=Gl0′ (30a)

R1=Gl1′ (30b)

R2=Gl2′ (30c).

When Equations (24a) to (24c) and Equation (29) are substituted into Equations (30a) to (30c),

R0=3×(1−Gt)×Gl0/(Gl0+Gl1+Gl2) (31a)

R1=3×(1−Gt)×Gl1/(Gl0+Gl1+Gl2) (31b)

R2=3×(1−Gt)×Gl2/(Gl0+Gl1+Gl2) (31c).

Next, a case of Gl+Gt≤1 is described. Hereinafter, it is described on the assumption that a transmittance T0 and a selection ratio R0 are first decided, a transmittance T1 and a selection ratio R1 are then decided, and lastly, a transmittance T2 and a selection ratio R2 are decided. However, the decision order may be appropriately changed.

First, the transmittance T0 and the selection ratio R0 are decided. A transparency gradation value Gt0 needed only in field 0 is as follows from Equation (23).

Gt0=Gt{(1−R0)×T0}/3 (32)

T0 and R0 are as follows from Equation (32) and Equation (22a), respectively.

T0=3GT+Gl0 (33)

R0=Gl0/(3Gt+Gl0) (34)

Next, the transmittance T1 and the selection ratio R1 are decided. First, a case of T0≤1 is described. The transparency gradation value is satisfied in field 0, so that from Equation (23),

(1−R1)×T1=0 (35).

From Equation (35) and Equation (22b),

R1=1 (36)

T1=Gl1 (37).

Similarly,

R2=1 (38)

T2=Gl2 (39).

Next, a case of T0>1 is described. T0 cannot be greater than “1”, so tha T0 is set to be maximum. As a result,

T0=1 (40).

At this time, from Equation (22a) and Equation (32), respectively,

R0=Gl0 (41)

Gt0=(1−Gl0)/3 (42).

In this case, only field 0 cannot satisfy the necessary transparency gradation value Gt. Thus, when a transparency gradation value that can be allotted to field 1 is Gt1, to satisfy the rest of the transparency gradation value in field 1, from Equation (23),

Gt1=Gt−Gt0={(1−R1)×T1}/3 (43).

When Equation (22b) is substituted into Equation (43),

T1=Gl1+3Gt1=Gl1+3(Gt−Gt0) (44).

When Equation (44) is substituted into Equation (22b),

R1=Gl1/T1=Gl1/{Gl1+3×(Gt−Gt0)} (45).

Lastly, the transmittance T2 and the selection ratio R2 are decided. First, a case of T1≤1 is described. The transparency gradation value is satisfied in fields 0, 1, so that from Equation (23),

(1−R2)×T2=0, in another expression, R2=1 (46).

When Equation (46) is substituted into Equation (22c),

T2=Gl2 (47).

Next, a case of T1>1 is described. T1 cannot be greater than “1”, so that T1 is set to be maximum. As a result,

T1=1 (48).

At this time, from Equation (22b) and Equation (23), respectively,

R1=Gl1 (49)

Gt1=(1−Gl1)/3 (50).

In this case, only fields 0 and 1 cannot satisfy the necessary transparency gradation value Gt. Thus, when a transparency gradation value that can be allotted to field 2 is Gt2, to satisfy the rest of the transparency gradation value in field 2, from Equation (23),

Gt2=Gt−(Gt0+Gt1)={(1−R2)×T2}/3 (51).

When Equation (22c) is substituted into Equation (51),

Gt2=(T2−Gl2)/3 (52).

When Equation (52) is solved for T2,

T2=Gl2+3Gt2=Gl2+3{Gt−(Gt0+Gt1)} (53).

When Equation (53) is substituted into Equation (22c),

R2=Gl2/T2=Gl2/{Gl2+3{(Gt−(Gt0+Gt1))}} (54).

### 3.1.2 Flowchart

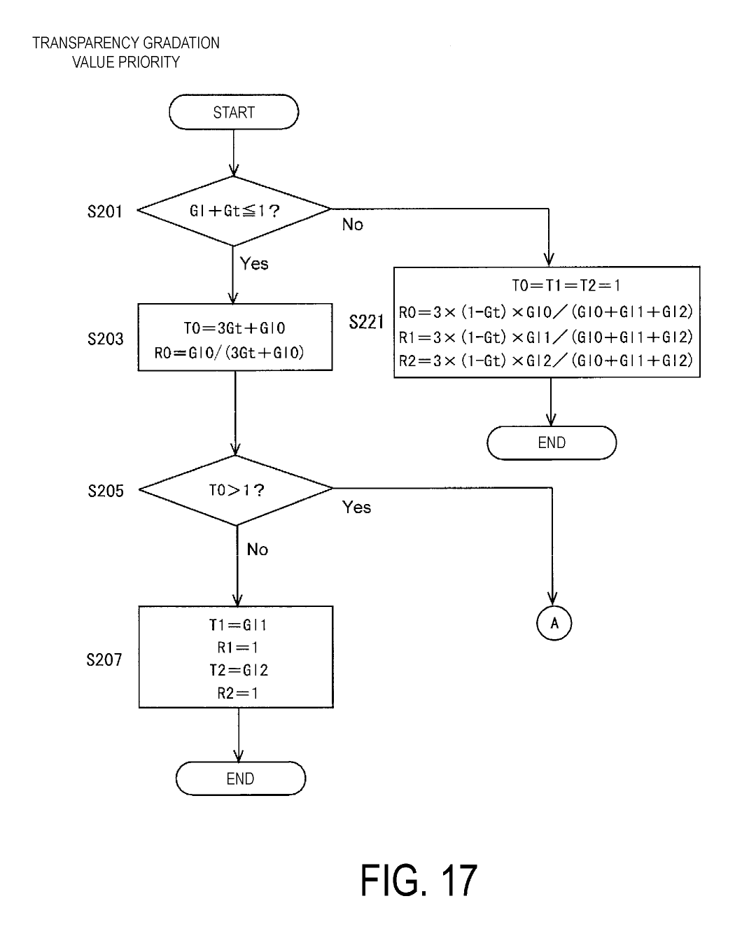

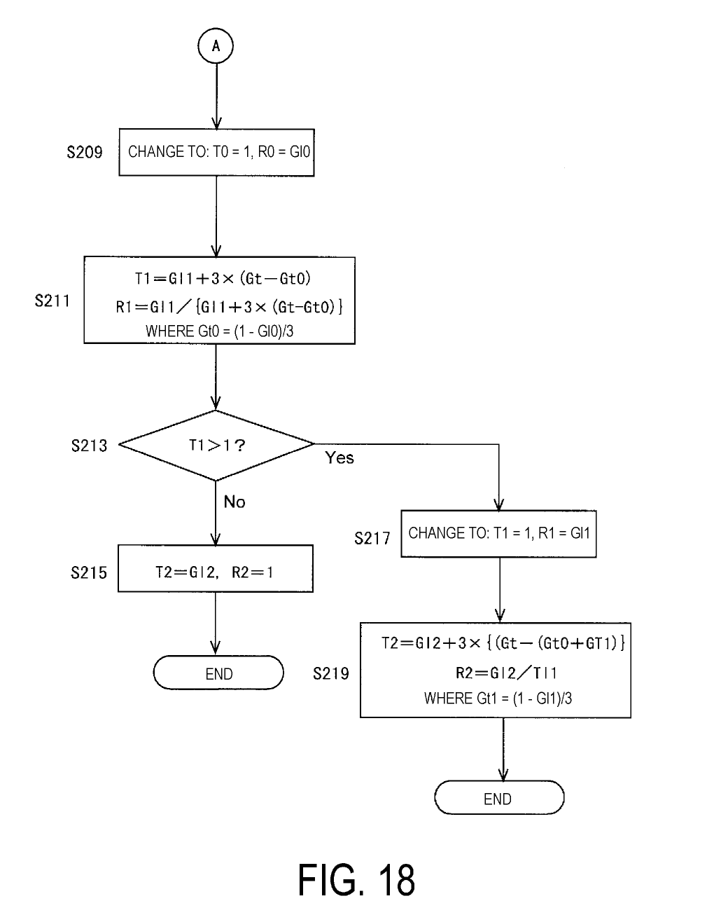

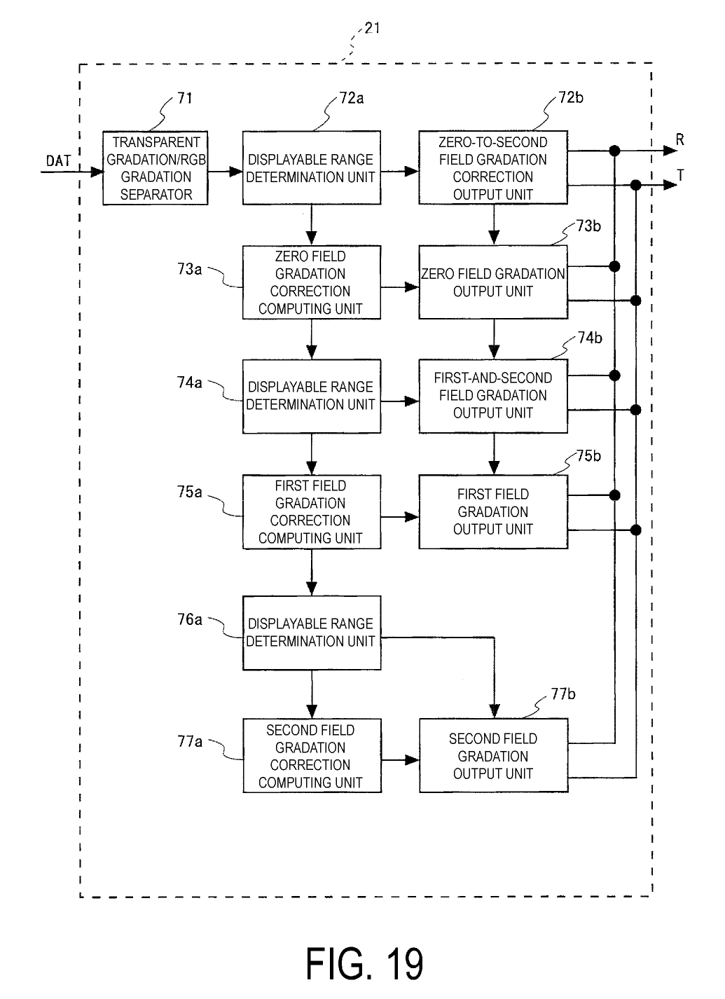

Next, procedure for obtaining the selection ratios R0, R1, R2 and the transmittance T in the respective fields is described with reference to a flowchart. FIGS. 17 and 18 are flowcharts illustrating the procedure for obtaining the selection ratios R0, R1, R2 and the transmittance T in the case of the transparency gradation value priority in the present embodiment.

As illustrated in FIGS. 17 and 18, first, in Step S201, it is determined whether a total value of the display gradation average value Gl and the transparency gradation value Gt satisfies Relationship (6) described above. In a case where it is determined that the total value of the display gradation average value Gl and the transparency gradation value (it satisfies Relationship (6) (in a case where it is determined YES), the processing proceeds to Step S203. In Step S203, the selection ratio R0 and the transmittance T0 in field 0 are obtained by Equation (33) and Equation (34), respectively.

In Step S205, it is determined whether the transmittance T0 in field 0 is greater than “1”. As a result, in a case where it is determined that the transmittance in field 0 is less than or equal to “1” (in a case where it is determined NO), the processing proceeds to Step S207. The selection ratio R1 and the transmittance T1 in field 1 and the selection ratio R2 and the transmittance T2 in field 2 are obtained by Equations (36) to (39), respectively. Then, the processing is terminated.

On the other hand, in a case where it is determined that the transmittance in field 0 is greater than “1” (in a case where it is determined YES) in Step S205, the processing proceeds to Step S209. In Step S209, the transmittance T0 obtained in Step S203 is changed to the transmittance T0 obtained in Equation (40), and the selection ratio R0 is changed to the selection ratio R0 obtained by Equation (41). In Step S211, the transmittance T1 in field 1 is obtained by Equation (44), and the selection ratio R1 is obtained by Equation (45).

In Step S213, it is determined whether the transmittance T1 obtained in Step S211 is greater than “1”. As a result, in a case where it is determined that the transmittance T1 is less than or equal to “1” (in a case where it is determined NO), the processing proceeds to Step S215. In Step S215, the selection ratio R2 in field 2 is expressed by Equation (46), and the transmittance T2 is expressed by Equation (47). Then, the processing is terminated.

On the other hand, in a case where it is determined that the transmittance T1 obtained in Step S211 is greater than “1” (in a case where it is determined YES) in Step S213, the processing proceeds to Step S217. In Step S217, the transmittance T1 obtained in Step S211 is changed to the transmittance T1 expressed by Equation (48), and the selection ratio R1 is changed to the selection ratio R1 expressed by Equation (49). In Step S219, the transmittance T2 in field 2 is set to the transmittance T2 expressed by Equation (53), and the selection ratio R2 is set to the selection ratio R2 expressed by Equation (54). Then, the processing is terminated.

On the other hand, as a result of the determination in Step S201, in a case where it is determined that the total value of does not satisfy Relationship (6) (in a case where it is determined NO), the processing proceeds to Step S221. In Step S221, the transmittances T0 to T2 in respective fields 0 to 2 are obtained by Equation (27) and the selection ratios R0 to R2 are obtained by Equations (31a) to (31c), respectively. Then, the processing is terminated.

In this way, not only in the case where (Gl+Gt) is less than or equal to 1 but also in the case where (Gl+Gt) is greater than “1”, the transparency gradation value priority allows the selection ratios R0 to R2 and the transmittances T0 to T2 in respective fields 0 to 2, respectively, to be obtained.

### 3.1.3 Functional Block Diagram of Image information Signal Conversion Circuit

FIG. 19 is a functional block diagram illustrating, by functions, the image information signal conversion circuit 21 included in the drive control circuit unit 20 illustrated in FIG. 3. As illustrated in FIG, 19, the image information signal conversion circuit 21 includes a transparent gradation/RGB gradation separator 71, displayable range determination units 72a, 74a, 76a, field gradation output units 72b, 74b, 77b that correspond to the displayable range determination units 72a, 74a, 76a, respectively, field gradation correction computing units 73a, 75a, 77a, and field gradation output units 73b, 75b, 77b that correspond to the field gradation correction computing units 73a, 75a, 77a, respectively.

When the image information signal DAT is provided from the outside to the transparent gradation/RGB gradation separator 71, the transparent gradation/RGB gradation separator 71 separates the transparency gradation value Gt and the display gradation value Gl from the image information signal DAT and provides the transparency gradation value Gt and the display gradation value Gl to the displayable range determination unit 72a. The displayable range determination unit 72a determines whether a sum of the transparency gradation value Gt and the display gradation average value Gl obtained from the display gradation values Gl is less than or equal to 1, in other words, whether the image is within the displayable range. This corresponds to Step S201 illustrated in FIG. 17. In a case where the displayable range determination unit 72a determines that the image is not within the displayable range, the displayable range determination unit 72a obtains the selection ratios R0 to R2 and the transmittances T0 to T2 in the respective fields, and outputs the selection ratios R0 to R2 and the transmittances T0 to T2 to the zero-to-second field gradation output unit 72b. This corresponds to Step S221. The zero-to-second field gradation output unit 72b outputs the provided selection ratios R0 to R2 and the transmittances T0 to T2 in the respective fields to the first liquid crystal panel drive circuit 23 and the second liquid crystal panel drive circuit 24, respectively.

In a case where the displayable range determination unit 72a determines that the image is within the displayable range, the zero field gradation correction computing unit 73a obtains the selection ratio R0 and the transmittance T0 in the zero field, and outputs the selection ratio R0 and the transmittance T0 to the zero field gradation output unit 73b. This corresponds to Step S203. The zero field gradation output unit 73b outputs the provided selection ratios R0 to R2 and the transmittances T0 to T2 in the respective fields to the first liquid crystal panel drive circuit 23 and the second liquid crystal panel drive circuit 24, respectively.

Next, the displayable range determination unit 74a determines whether the transmittance T0 in the zero field is greater than 1. This corresponds to Step S205. In a case where it is determined that the transmittance T0 is less than or equal to 1 as a result of the determination, the displayable range determination unit 74a obtains the selection ratios R1, R2 and the transmittances T1, T2 in the respective fields that are first and second fields, and outputs the selection ratios R1, R2 and the transmittances T1, T2 to the first-and-second field gradation output unit 74b. This corresponds to Step S207. The first-and-second field gradation output unit 74b outputs the provided selection ratios R1, R2 and the transmittances T1, T2 in the respective fields to the first liquid crystal panel drive circuit 23 and the second liquid crystal panel drive circuit 24, respectively.

In a case where the displayable range determination unit 74a determines that the transmittance T0 in the zero field is greater than 1, the first field gradation correction computing unit 75a obtains the selection ratio R1 and the transmittance T1 in the first field, and outputs the selection ratio R1 and the transmittance T1 to the first field gradation output unit 75b. This corresponds to Step S211. The first field gradation output unit 75b outputs the provided selection ratio R1 and the transmittance T1 in the first field to the first liquid crystal panel drive circuit 23 and the second liquid crystal panel drive circuit 24, respectively.

Next, the displayable range determination unit 76a determines whether the transmittance T1 in the first field is greater than 1. This corresponds to Step S213. In a case where it is determined that the transmittance T1 is less than or equal to 1 as a result of the determination, the displayable range determination unit 76a obtains the selection ratio R2 and the transmittance T2 in the second field, and outputs the selection ratio R2 and the transmittance T2 to the second field gradation output unit 77b. This corresponds to Step S215. On the other hand, in a case where it is determined that the transmittance T1 is greater than 1, the second field gradation correction computing unit 77a obtains the selection ratio R2 and the transmittance T2 in the second field, and outputs the selection ratio R2 and the transmittance 12 to the second field gradation output unit 77b. This corresponds to Step S219. The second field gradation output unit 77b outputs the selection ratio R2 and the transmittance T2 in the second field provided by the displayable range determination unit 76a or the second field gradation correction computing unit 77a to the first liquid crystal panel drive circuit 23 and the second liquid crystal panel drive circuit 24, respectively.

In this way, the image information signal conversion circuit 21 can obtain the selection ratios R0 to R2 and the transmittances T0 to T2 in the respective fields.

### 3.1.4 Display State

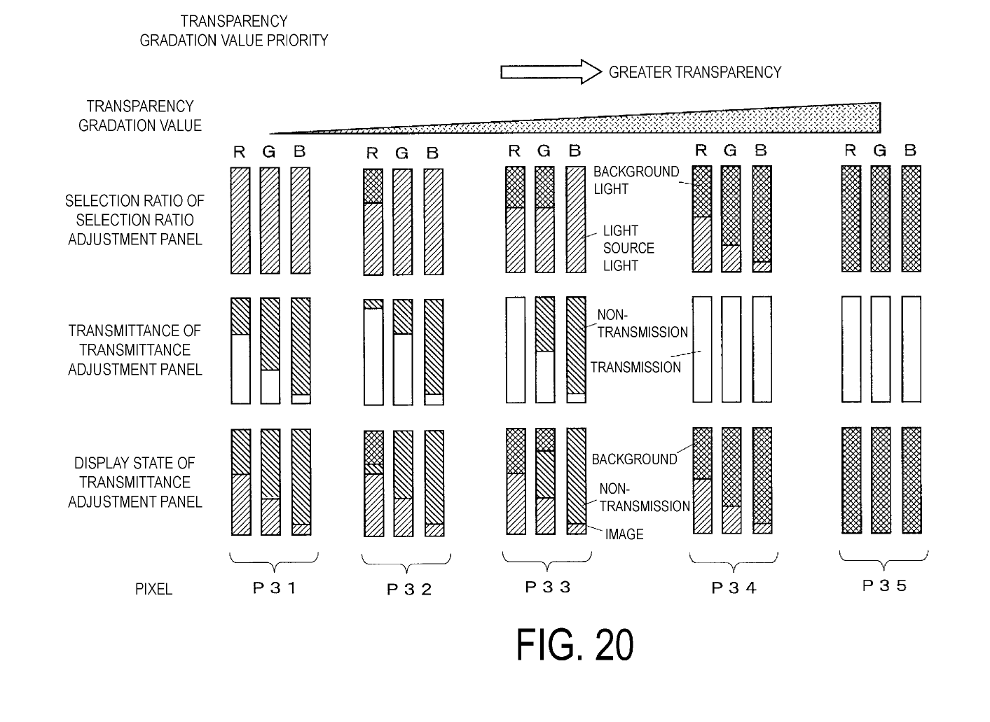

A change of an image or a background displayed when being adjusted according to the transparency gradation value priority as the transparency gradation value increases in a case where a color of the light source light emitted from the backlight light source 50 changes by each of fields by field sequential driving is described. FIG. 20 is a diagram illustrating transmission states of the light source light and the background light when the display gradation values and the transparency gradation value are adjusted according to the transparency gradation value priority. In FIG. 20, as the transparency gradation value changes, a selection ratio of the selection ratio adjustment panel 35, a transmittance of the transmittance adjustment panel 36, and a display state of the transmittance adjustment panel 36 are illustrated by 5 stages that are states P31 to P35. Specifically, the transparency gradation value Gt changes in the order of “0”, “0.1”, “0.2”, “0.7”, and “1” from the state P31 to the state P35, respectively. The display gradation value Gl0, the display gradation value Gl1, and the display gradation value Gl2 in fields 0 to 2 are “0.6”, “0.3”, and “0.1”, respectively, regardless of a value of the transparency gradation value Gt. In this way, the display gradation average value Gl in fields 0 to 2 is “0.33” from Equation (21). Hereinafter, the states P31 to P35 are described one after another.

In the state P31, the display gradation average value Gl is “0.33” and the transparency gradation value Gt is “0”. In Step S201, it is determined that (Gl+Gt) is less than or equal to “1”, and the processing proceeds to Step S203. In field 0, the selection ratio R0 is “1” and the transmittance T0 is “0.6” from Equation (3) and Equation (4) described above, respectively. Thus, the display gradation value Gl0 is “0.6” and the transparency gradation value Gt0 is “0” from Equations (1) and (2), respectively, and the non-transmission Gn0 is “0.4” from Equation (5). As a result, only the image is displayed in field 0.

In field 1, the selection ratio R1 is “1” and the transmittance T1 is “0.3” from Equation (3) and Equation (4) described above, respectively. Thus, the display gradation value Gl1 is “0.6” and the transparency gradation value Gt1 is “0” from Equations (1) and (2), respectively, and the non-transmission Gn1 is “0.7” from Equation (5). As a result, only the image is displayed also in field 1.

In field 2, the selection ratio R2 is “1” and the transmittance T2 is “0.1” from Equation (3) and Equation (4) described above, respectively. Thus, the display gradation value Gl2 is “0.1” and the transparency gradation value Gt2 is “0” from Equations (1) and (2), respectively, and the non-transmission Gn2 is “0.9” from Equation (5). As a result, only the image is displayed also in field 2.

In the state P32, the display gradation average value Gl is “0.33” and the transparency gradation value Gt is “0.1”. In Step S201, it is determined that (Gl+Gt) is less than or equal to “1”, and the processing proceeds to Step S203. The method for obtaining a selection ratio and a transmittance in each of fields 0 to 2 is the same as or similar to the method for obtaining a selection ratio and a transmittance described in the state P31, so that only results are described below. In field 0, the display gradation value Gl0 is “0.6”, the transparency gradation value Gt0 is “0.3”, and the non-transmission Gn0 is “0.1”. As a result, the image and the background overlapping each other are displayed in field 0. In field 1, the display gradation value Gl1 is “0.3”, the transparency gradation value Gt1 is “0”, and the non-transmission Gn1 is “0,7”. As a result, only the image is displayed in field 1. In field 2, the display gradation value Gl2 is “0.1”, the transparency gradation value Gt2 is “0”, and the non-transmission Gn2 is “0.9”. As a result, only the image is displayed also in field 2.

In the state P33, the display gradation average value Gl is “0.33” and the transparency gradation value Gt is “0.2”. In Step S201, it is determined that (Gl+Gt) is less than or equal to “1”, and the processing proceeds to Step S203. In field 0, the display gradation value Gl0 is “0.6”, the transparency gradation value Gt0 is “0.4”, and the non-transmission Gn0 is “0”. As a result, the image and the background overlapping each other are displayed in field 0. In field 1, the display gradation value Gl1 is “0.3”, the transparency gradation value Gt1 is “0.2”, and the non-transmission Gn1 is “0.5”. As a result, the image and the background overlapping each other are displayed also in field 1. In field 2, the display gradation value Gl2 is “0.1”, the transparency gradation value Gt2 is “0”, and the non-transmission Gn2 is “0.9”. As a result, only the image is displayed in field 2.

In the state P34, the display gradation average value Gli is “0.33” and the transparency gradation value Gt is “0.7”. In Step S201, it is determined that (Gl+Gt) is greater than “1”, and the processing proceeds to Step S221. In field 0, the display gradation value Gl0 is “0.54”, the transparency gradation value Gt0 is “0.46”, and the non-transmission Gn0 is “0”. As a result, the image and the background overlapping each other are displayed in field 0. In field 1, the display gradation value Gl1 is “0.27”, the transparency gradation value Gt1 is “0.73”, and the non-transmission Gn1 is “0”. As a result, the image and the background overlapping each other are displayed also in field 1. In field 2, the display gradation value Gl2 is “0.09”, the transparency gradation value Gt2 is “0.91”, and the non-transmission Gn2 is “0”. As a result, the image and the background overlapping each other are displayed also in field 2.

In the state P35, the display gradation average value Gl is “0.33” and the transparency gradation value Gt is “1”. In Step 5201, it is determined that (Gl+Gt) is greater than “1”, and the processing proceeds to Step S221. The display gradation values Gl0, Gl1, Gl2 in respective fields 0 to 2 are all “0”, and the transparency gradation values Gt0, Gt1, Gt2 are all “1”. As a result, only the background is displayed in all fields 0 to 2.

### 3.2 For Display Gradation Value Priority

### 3.2.1 How to Obtain Selection Ratio and Transparency

Ranges of values on which the transparency gradation value Gt, the display gradation values Gl0, Gl1, Gl2, the selection ratios R0, R1, R2, and the transmittances T0, T1, T2 may take, and their relationships are the same as those in the case of the transparency gradation value priority. Thus, their description will be omitted.

First, a case of Gl+Gt>1 is described. In this case, as described in the basic study, both of an image and a background cannot be displayed. Then, the display gradation value is prioritized to lead to a state in which the image and the background can be displayed. When the display gradation value is prioritized, a value of the transparency gradation value Gt is adjusted to be smaller without changing a value of the display gradation value Gl to be a transparency gradation value Gt′. Accordingly,

Gl+Gt′=1 (61).

When Equation (61) is substituted into Equation below,

Gl+Gt′=(Gl0+Gl1+Gl2)/3+gt′=1 (62).

When Equations (22a) to (22c) and Equation (23) are substituted into Equation (62) and organized,

T0+T1+T2=3 (63).

Since 0≤T0≤1, 0≤T1≤1, 0≤T2≤1,

T0=T1=T2=1 (64).

The display gradation value is not changed, so that Gl0, Gl1, and Gl2 are also not changed, Therefore, when Equation (64) is substituted into Equations (22a) to (22c),

R0=Gl0 (65a)

R1=Gl1 (65b)

R2=Gl2 (65c).

Note that the case of Gl+Gt≤1 is the same as the case of the transparency gradation value priority, so that its description will be omitted.

### 3.2.2 Flowchart

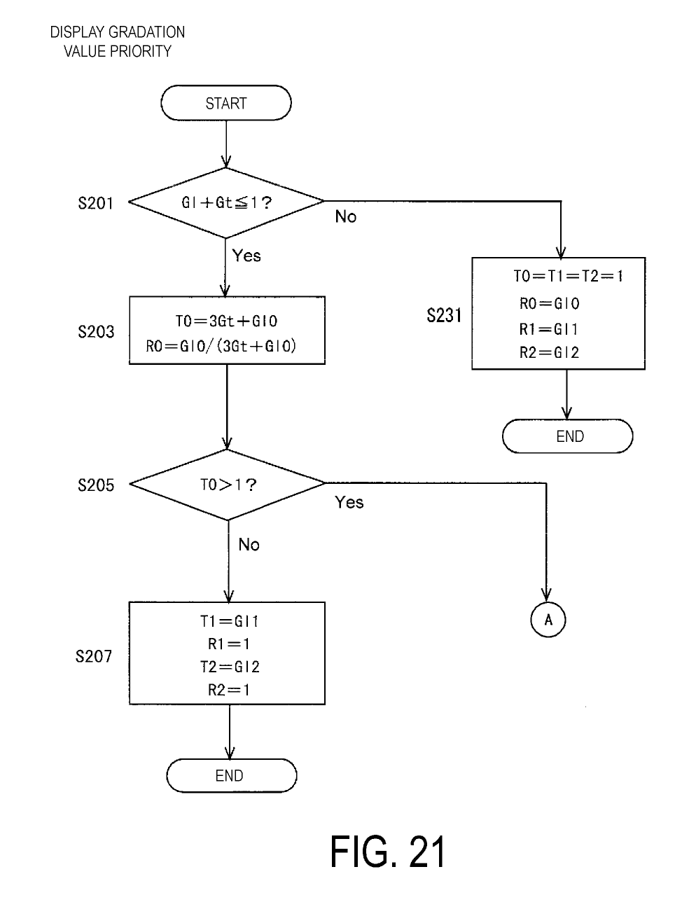

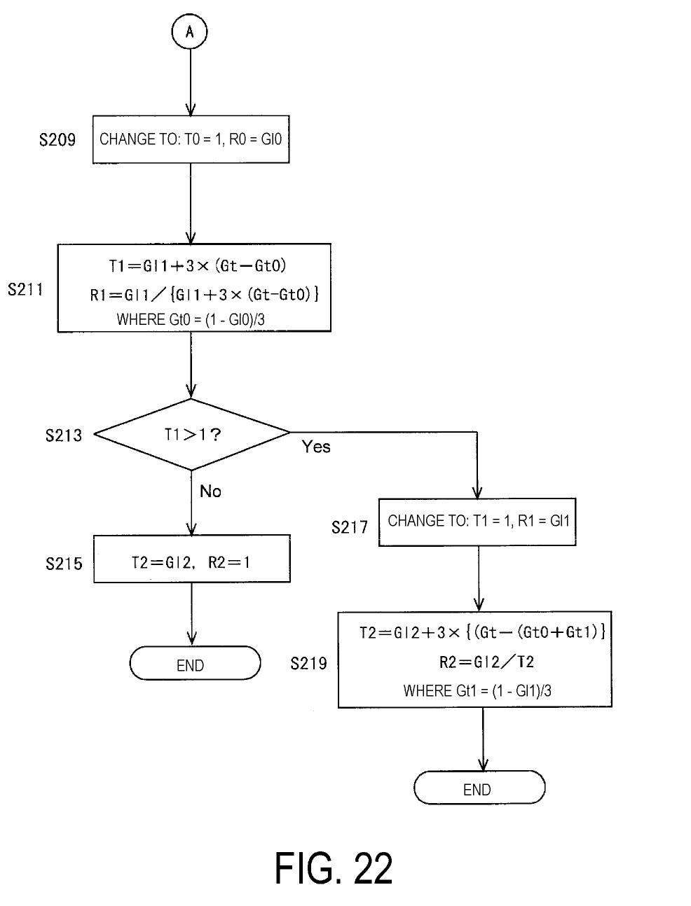

Next, procedure for obtaining the selection ratios R0 to R2 and the transmittances T0 to T2 in the respective fields is described with reference to a flowchart. FIGS. 21 and 22 are flowcharts illustrating procedure for obtaining the selection ratios R0 to R2 and the transmittances T0 to T2 in the case of the display gradation value priority in the present embodiment.

As illustrated in FIGS. 21 and 22, in Step S201, it is determined whether a total value of the display gradation average value Gl and the transparency gradation value Gt satisfies Relationship (6) described above, As a result of the determination, in a case where it is determined that the total value satisfies Relationship (6) (in a case where it is determined YES), the processing proceeds to Step S203. The processing in steps subsequent to Step S203 is the same as processing from Step S203 to Step S219 in the case of the transparency gradation value priority. Accordingly, the steps that perform the same processing as that in the steps when the transparency gradation value is prioritized are denoted by the same reference numerals, and their description will be omitted.

On the other hand, in Step S201, in a case where it is determined that the total value does not satisfy Relationship (6) (in a case where it is determined NO), the processing proceeds to Step S231. In Step S231, the transmittances T0 to T2 in respective fields 0 to 2 are obtained by Equation (27) and the selection ratios R0 to R2 are obtained by Equations (65a) to (65c), respectively.

### 3.2.3 Display State

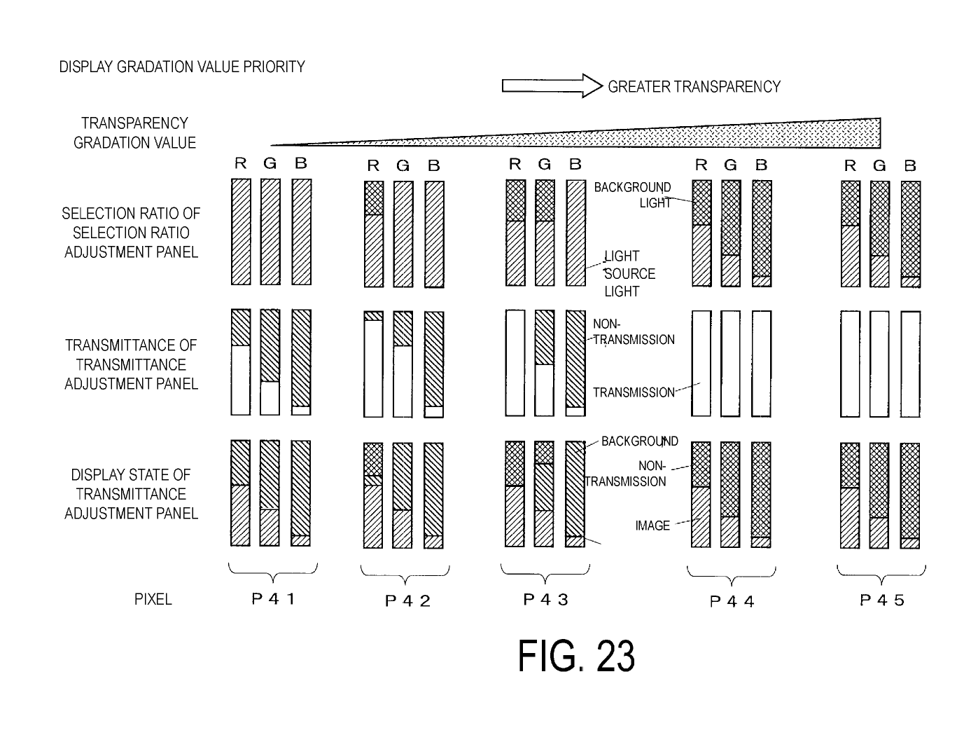

A change of the image or the background displayed when being adjusted according to the display gradation value priority is described. FIG. 23 is a diagram illustrating transmission states of the light source light and the background light when the display gradation values and the transparency gradation value are adjusted according to the display gradation value priority. In FIG. 23, as the transparency gradation value changes, a selection ratio of the selection ratio adjustment panel 35, a transmittance of the transmittance adjustment panel 36, and a display state of the transmittance adjustment panel 36 are illustrated by 5 stages that are states P41 to P45. Specifically, the transparency gradation value Gt changes in the order of “0”, “0.1”, “0.2”, “0.7”, and “1” from the state P41 to the state P45, respectively. The display gradation value Gl0, the display gradation value Gl1, and the display gradation value Gl2 in fields 0 to 2 are “0.6”, “0.3”, and “0.1”, respectively, regardless of a value of the transparency gradation value Gt. In this way, the display gradation average value Gl in fields 0 to 2 is “0.33” from Equation (21).

In the state P41 to the state P43, it is determined that (Gl+Gt) is less than or equal to “1” in Step S201, so that the display gradation values Gl0 to Gl2 and the transparency gradation values Gt0 to Gt2 in respective fields 0 to 2 are respectively the same as those in the state P31 to the state P33 at the transparency gradation value priority illustrated in FIG. 20. Thus, the description of the state P41 to the state P43 will be omitted.

In the state P44, the display gradation average value Gl is “0.33” and the transparency gradation value Gt is “0.7”. In Step S201, it is determined that (Gl+Gt) is greater than “1”, and the processing proceeds to Step S231. In field 0, the selection ratio R0 is “0.6” from Equation (30a), and the transmittance T0 is “1” from Equation (27). Thus, the display gradation value Gl0 is “0.6” and the transparency gradation value Gt0 is “0.4” from Equations (1) and (2), respectively, and the non-transmission Gn0 is “0” from Equation (5). As a result, the image and the background overlapping each other are displayed in field 0. Similarly, in field 1, the display gradation value Gl1 is “0.3”, the transparency gradation value Gt1 is “0.7”, and the non-transmission Gn1 is “0”. As a result, the image and the background overlapping each other are displayed also in field 1. In field 2, the display gradation value Gl2 is “0.3”, the transparency gradation value Gt2 is “0.7”, and the non-transmission Gn2 is “0”. As a result, the image and the background overlapping each other are displayed also in field 2.

Also in the state P45 similar to the state P44, it is determined that (Gl+Gt) is greater than “1”, and the processing proceeds to Step S231. Similar to the case of the state P44, in field 0, the selection ratio R0 is “0.6” from Equation (30a), and the transmittance T0 is “1” from Equation (27). Thus, the display gradation values Gl0 to Gl2 and the transparency gradation values Gt0 to Gt2 in respective fields 0 to 2 are the same as those in the case of the state P44. Accordingly, the image and the background overlapping each other are displayed.

### 3.3 Effects

According to the present embodiment, even when an image specified by the display gradation values and the transparency gradation value included in the image information signal is not within a displayable range in the liquid crystal display device that displays a color image, the display gradation values and the transparency gradation value can be adjusted by prioritizing the transparency gradation value or prioritizing the display gradation values. In this way, the liquid crystal display device can display a color image, make a background transparent to be displayed, and display a color image and a background overlapping each other regardless of whether the image specified by the display gradation values and the transparency gradation value is within the displayable range.

### 4. Third Embodiment

A liquid crystal display device according to a third embodiment will be described. The liquid crystal display device according to the second embodiment displays a color image formed by the three fields by field sequential driving that lights each of the red, green, and blue LEDs of the backlight light source 50 one after another at high speed. However, the liquid crystal display device according to the present embodiment generalizes the case in the second embodiment and displays a color image formed by N (where N is a natural number of greater than or equal to 1) fields. Note that the configuration of the liquid crystal display device illustrated in FIGS. 3 to 5 and the operation principle of the liquid crystal display device illustrated in FIGS. 6 and 7 are the same as those in the case of the liquid crystal display device according to the present embodiment. Thus, their diagrams and description will be omitted.

### 4.1 For Transparency Gradation Value Priority

### 4.1.1 Flowchart

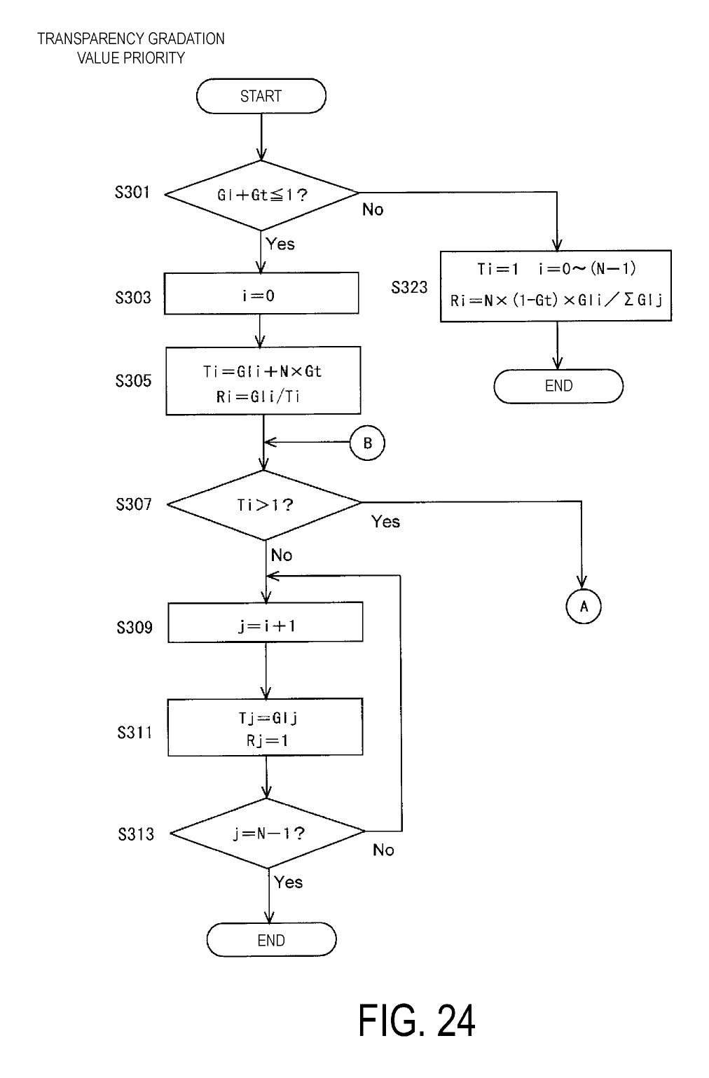

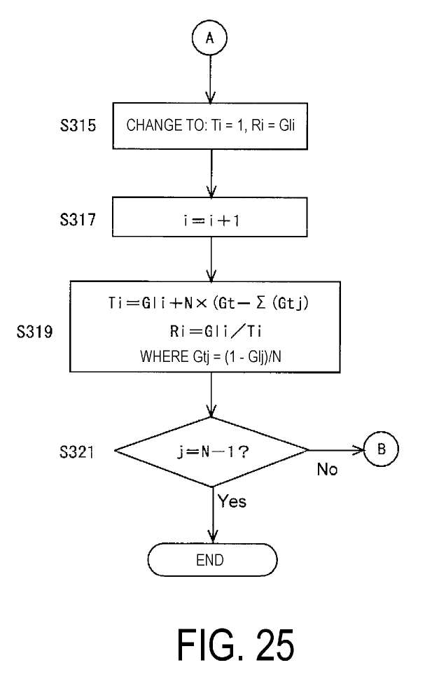

Procedure for obtaining selection ratios Ri (i=1 to (N−1)) 0 and transmittances Ti in respective fields in a case of transparency gradation value priority is described with reference to flowcharts. FIGS. 24 and 25 are flowcharts illustrating procedure for obtaining the selection ratios Ri and the transmittances Ti in the case of the transparency gradation value priority in the present embodiment. The third embodiment corresponds to the generalized second embodiment, so that the description is given in comparison with the flowcharts of the second embodiment.

As illustrated in FIGS. 24 and 25, first, in Step S301, it is determined whether a total value of the display gradation average value Gl and the transparency gradation value Gt satisfies Relationship (6) described above. As a result of the determination, in a case where it is determined that the total value of the display gradation average value Gl and the transparency gradation value Gt satisfies Relationship (6) (in a case where it is determined YES), the processing proceeds to Step S303 and sets i=0. The processing further proceeds to Step S305, and the selection ratio R0 and the transmittance T0 in field 0 are obtained by Equation (71) and Equation (72) below, respectively, that are generalized from Equation (33) and Equation (34).

Ti=Gli+N×Gt (71)

Ri=Gli/Ti (72)

In Step S307, it is determined whether the transmittance Ti in field i is greater than “1”. As a result, in a case where it is determined that the transmittance Ti is less than or equal to “1” (in a case where it is determined NO), the processing proceeds to Step S309 and sets j=(1+i). Furthermore, in Step S311, a transmittance Tj and a selection ratio Rj in field j are obtained by Equation (73) and Equation (74) below, respectively, that correspond to Equations (36) to (39).

Tj=Glj (73)

Rj=1 (74)

In Step S313, it is determined whether j is equal to (N−1). In a case where it is determined that j is not equal to (N−1) (in a case where it is determined NO), the processing returns to Step S309. In a case where it is determined that j is equal to (N−1) (in a case where it is determined YES), the processing is terminated.

On the other hand, in a case where it is determined that the transmittance Ti in field i is greater than “1” (in a case where it is determined YES) in Step S307, the processing proceeds to Step S315. In Step S315, the transmittance Ti and the selection ratio Ri obtained in Step S305 are changed according to Equation (75) and Equation (76) below, respectively.

Ti=1 (75)

Ri=Gli (76)

In Step S317, it is set that i=i+1. In Step S319, the transmittance Ti and the selection ratio Ri in field i are obtained by Equation (79) and Equation (80) below that correspond to Equation (44) and Equation (45), respectively.

Ti=Gli+N×(Gt−Σ(Gtj)) (77)

Ri=Gli/Ti (78)

where Gtj=(1−Glj)/N.

In Step S321, it is determined whether j is equal to (N−1). In a case where it is determined that j is not equal to (N−1) (in a case where it is determined NO), the processing returns to Step S307. In a case where it is determined that j is equal to (N−1) (in a case where it is determined YES), the processing is terminated.

On the other hand, in Step S301, in a case where it is determined that the total value does not satisfy Relationship (6) (in a case where it is determined NO), the processing proceeds to Step S323. In Step S323, the transmittance Ti in each of fields 0 to (N−1) is obtained by Equation (71) generalized from Equation (27). The selection ratio Ri in each of fields 0 to (N−1) is obtained by Equations (79) and (80) below generalized from Equations (31a) to (31c). Then, the processing is terminated.

Ti=1(i=0 to (N−1)) (79)

Ri=N×(1−Gt)×Gli/ΣGlj(j=0 to (N−1)) (80)

### 4.1.2 Specific Application Example

A case where a color image formed by four fields is displayed is described by applying flowcharts of the above-described N fields. When the liquid crystal display device is driven by field sequential driving to display a color image, a phenomenon called color breakup occurs in a case where an observer moves his/her line of sight at high speed. A method for adding a color mixture field has been known as one of methods for suppressing such color breakup. Accordingly, in the present embodiment, a white field is added as a color mixture field, and one frame is formed by four fields 0 to 3 in white, red, green, and blue. Thus, in the present embodiment, the respective red, green and blue LEDs 51r to 51b of the backlight light source 50 are simultaneously lighted to radiate white light source light, and then, the red light source light, the green light source light, and the blue light source light are radiated one after another in time division manner. Note that the red light source light, the green light source light, and the blue light source light may be radiated one after another before the radiation of the white light source light.

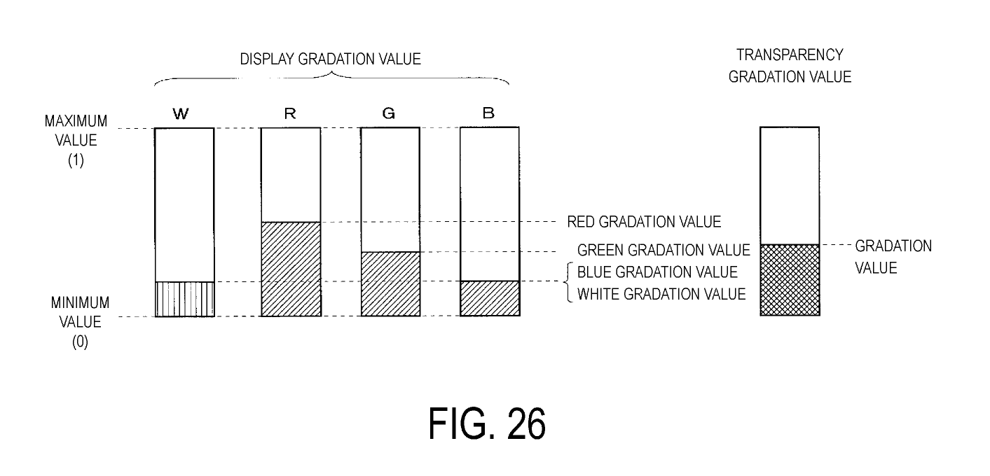

FIG. 26 is a diagram for describing display gradation values and a transparency gradation value included in an image information signal in the present embodiment. As illustrate in FIG. 26, the image information signal includes the display gradation values and the transparency gradation value that includes, similar to the second embodiment, only one transparency gradation value being common to fields 0 to 3. On the other hand, the display gradation value includes red, green, and blue display gradation values and also a white display gradation value corresponding to fields 0 to 3. Each of the display gradation values and the transparency gradation value is a gradation value within a range of “0” as a minimum value to “1” as a maximum value,

The white display gradation value is set to be a gradation value less than or equal to a minimum display gradation value among the red, green, and blue display gradation values. In FIG. 26, the white display gradation value is set to be a graduation value less than the minimum blue display gradation value. The display gradation values obtained by subtracting white display gradation value from the red, green, and blue display gradation values are set as new red, green, and blue display gradation values, respectively. Note that, in the present embodiment, it is assumed that the blue field has the minimum display gradation value. However, in a case where the red field has the minimum display gradation value, the white display gradation value is a gradation value less than or equal to the red display gradation value. In a case where the green field has the minimum display gradation value, the white display gradation value is a gradation value less than or equal to the green display gradation value.

### 4.1.3 Display State

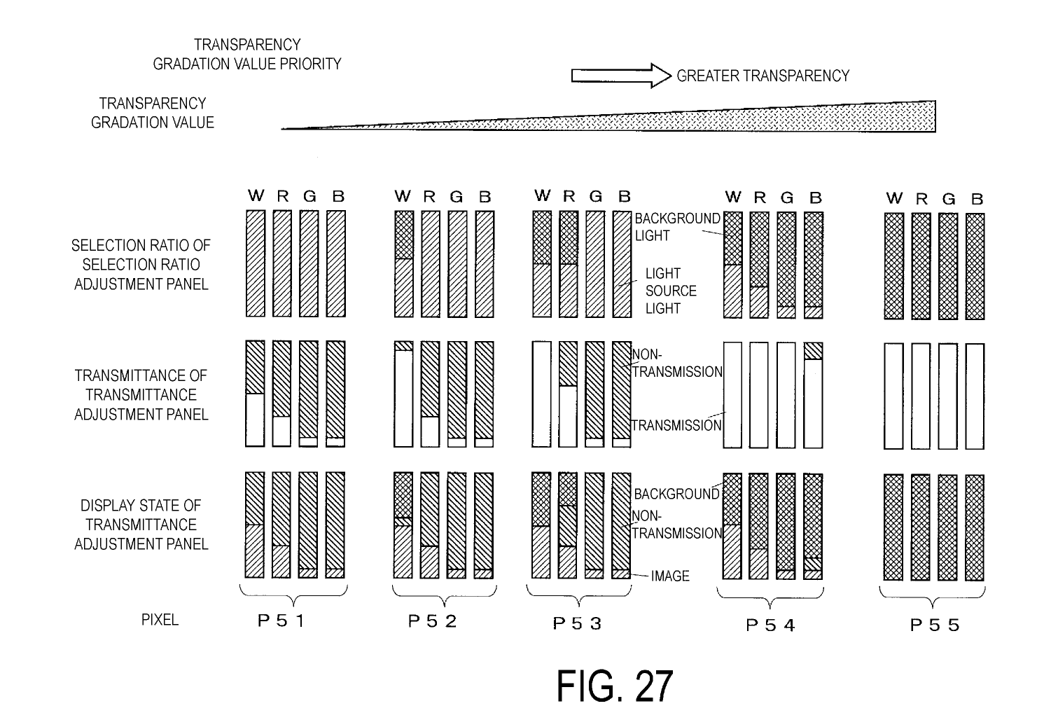

A change of an image or a background displayed when being adjusted according to the transparency gradation value priority as the transparency gradation value increases in a case where a color of the light source light emitted from the backlight tight source 50 changes by each of fields by field sequential driving is described. FIG. 27 is a diagram illustrating transmission states of the light source light and the background light when the display gradation values and the transparency gradation value are adjusted according to the transparency gradation value priority. In FIG. 27, a transparency gradation, a selection ratio of the selection ratio adjustment panel 35, a transmittance of the transmittance adjustment panel 36, and a display state of the transmittance adjustment panel 36 are illustrated vertically for each of the fields in five states P51 to P55 including different transparency gradation values and display gradation values. As illustrated in FIG. 27, the transparency gradation value in the state P51 is minimum. Transparency gradually increases toward the state P55, and the transparency gradation value in the state P55 is maximum.

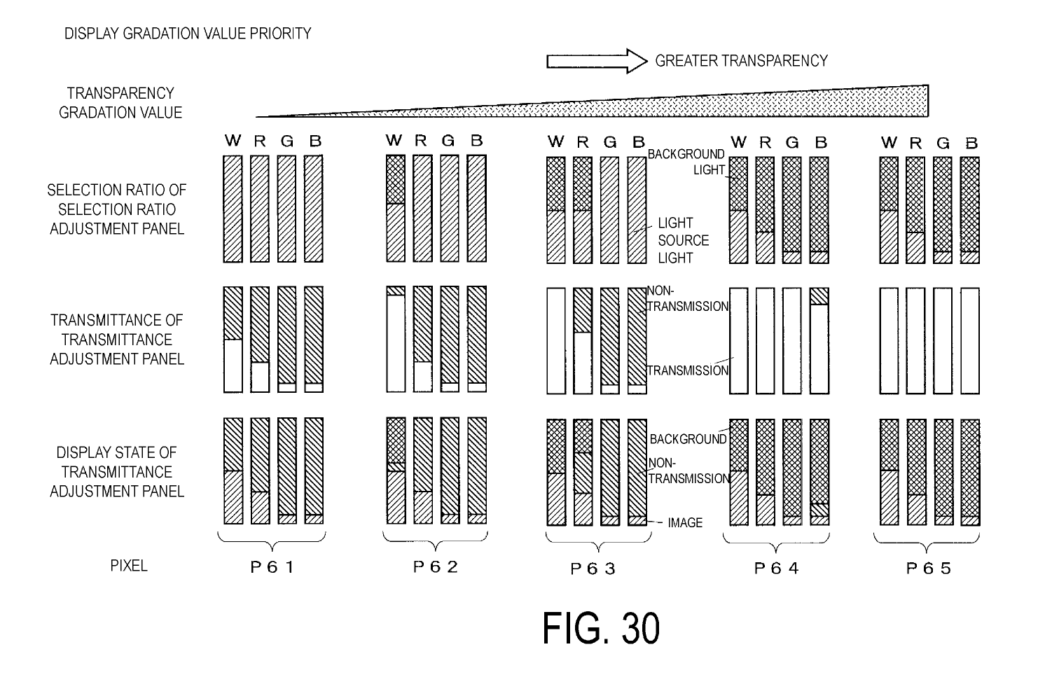

A change of an image or a background displayed when being adjusted according to the display gradation value priority as the transparency gradation value increases in a case where a color of the light source light emitted from the backlight light source 50 changes by every of fields by field sequential driving is described. FIG. 30 is a diagram illustrating a change in the display states when being adjusted according to the display gradation value priority when a transparency gradation value of an arbitrary pixel changes. In FIG. 30, as the transparency gradation value changes, a selection ratio of the selection ratio adjustment panel 35, a transmittance of the transmittance adjustment panel 36, and a display state of the transmittance adjustment panel 36 are displayed by 5 stages that are the states P61 to P65. Specifically, the transparency gradation value Gt changes in the order of “0”, “0.1”, “0.2”, “0.7”, and “1” from the state P61 to the state P65. The display gradation value Gl0, the display gradation value Gl1, the display gradation value Gl2, and the display gradation value Gl3 in fields 0 to 3 are “0.5”, “0.3”, “0.1”, and “0.1”, respectively, regardless of a value of the transparency gradation value Gt. In this way, the display gradation average value Gl in fields 0 to 3 is “0.25” from Equation (21). Hereinafter, the states P61 to P65 are described one after another. Note that, in the following description, it is described on the assumption that field 0, field 1, field 2, and field 3 are the white field, the red field, the green field, and the blue field, respectively. However, this is an example, and each of fields 0 to 3 is not limited thereto.

In the state P61, the display gradation average value Gl is “0.25” and the transparency gradation value Gt is “0”. In Step S301, it is determined that (Gl+Gt) is less than or equal to “1”, and the processing proceeds to Step S303. In field 0, the selection ratio R0 is “1” and the transmittance T0 is “0.5” from Equation (3) and Equation (4) described above, respectively. Thus, the display gradation value Gl0 is “0.5” and the transparency gradation value Gt0 is “0” from Equations (1) and (2), respectively, and the non-transmission Gn0 is “0.5” from Equation (5). As a result, only the image is displayed in field 0.

In field 1, the selection ratio R1 is “1” and the transmittance T1 is “0.3” from Equation (3) and Equation (4) described above, respectively. Thus, the display gradation value Gl1 is “0.3” and the transparency gradation value Gt1 is “0” from Equations (1) and (2), respectively, and the non-transmission Gn1 is “0.7” from Equation (5). As a result, only the image is displayed also in field 1.

In field 2, the selection ratio R2 is “1” and the transmittance T2 is “0.1” from Equation (3) and Equation (4) described above, respectively. Thus, the display gradation value Gl2 is “0.1” and the transparency gradation value Gt2 is “0” from Equations (1) and (2), respectively, and the non-transmission Gn2 is “0.9” from Equation (5). As a result, only the image is displayed also in field

In field 3, the selection ratio R3 is “1” and the transmittance T3 is “0.1” from Equation (3) and Equation (4) described above, respectively. Thus, the display gradation value Gl3 is “0.1” and the transparency gradation value Gt3 is “0” from Equations (1) and (2), respectively, and the non-transmission Gn3 is “0.9” from Equation (5). As a result, only the image is displayed also in field 3.

In the state P62, the display gradation average value Gl is “0.25” and the transparency gradation value Gt is “0.1”. In Step S301, it is determined that (Gl+Gt) is less than or equal to “1”, and the processing proceeds to Step S303. The method for obtaining a selection ratio and a transmittance in each of fields 0 to 2 is the same as or similar to the method for obtaining a selection ratio and a transmittance described in the state P31, so that only results are described below. In field 0, the display gradation value Gl0 is “0.5”, the transparency gradation value Gt0 is “0.4”, and the non-transmission Gn0 is “0.1”. As a result, the image and the background overlapping each other are displayed in field 0. In field 1, the display gradation value Gl1 is “0.3”, the transparency gradation value Gt1 is “0”, and the non-transmission Gn1 is “0.7”. As a result, only the image is displayed in field 1, in field 2, the display gradation value Gl2 is “0.1”, the transparency gradation value Gt2 is “0”, and the non-transmission Gn2 is “0.9”. As a result, only the image is displayed also in field 2. In field 3, the display gradation value Gl3 is “0.1”, the transparency gradation value Gt3 is “0”, and the non-transmission Gn3 is “0.9”. As a result, only the image is displayed also in field 3.

In the state P63, the display gradation average value Gl is “0.25” and the transparency gradation value Gt is “0.2”. In Step S301, it is determined that (Gl+Gt) is less than or equal to “1”, and the processing proceeds to Step S303. In field 0, the display gradation value Gl0 is “0.5”, the transparency gradation value Gt0 is “0.5”, and the non-transmission Gn0 is “0”. As a result, the image and the background overlapping each other are displayed in field 0. In field 1, the display gradation value Gl1 is “0.3”, the transparency gradation value Gt1 is “0.3”, and the non-transmission Gn1 is “0.4”. As a result, the image and the background overlapping each other are displayed also in field 1. In field 2, the display gradation value Gl2 is “0.1”, the transparency gradation value Gt2 is “0”, and the non-transmission Gn2 is “0.9”. As a result, only the image is displayed in field 2, in field 3, the display gradation value Gl3 is “0.1”, the transparency gradation value Gt3 is “0”, and the non-transmission Gn3 is “0.9”. As a result, only the image is displayed in field 3.

In the state P64, the display gradation average value Gl is “0.25” and the transparency gradation value Gt is “0.7”. In Step S301, it is determined that (Gl+Gt) is less than or equal to “1”, and the processing proceeds to Step S303. In field 0, the display gradation value Gl0 is “0.5”, the transparency gradation value Gt0 is “0.5”, and the non-transmission Gn0 is “0”. As a result, the image and the background overlapping each other are displayed in field 0. In field 1, the display gradation value Gl1 is “0.3”, the transparency gradation value Gt1 is “0.7”, and the non-transmission Gn1 is “0”. As a result, the image and the background overlapping each other are displayed also in field 1. In field 2, the display gradation value Gl2 is “0.1”, the transparency gradation value Gt2 is “0.9”, and the non-transmission Gn2 is “0”. As a result, the image and the background overlapping each other are displayed also in field 2. In field 3, the display gradation value Gl3 is “0.1”, the transparency gradation value Gt3 is “0.9”, and the non-transmission Gn3 is “0”. As a result, the image and the background overlapping each other are displayed also in field 3.

In the state P65, the display gradation average value Gl is “0.25” and the transparency gradation value Gt is “1”. In Step S301, it is determined that (Gl+Gt) is greater than “1”, and the processing proceeds to Step S303. The display gradation values Gl0, Gl1, Gl2, Gl3 in respective fields 0 to 3 are all “0”, and the transparency gradation values Gt0, Gt1, Gt2, Gt3 in respective fields 0 to 3 are all “1”. As a result, only the background is displayed in all fields 0 to 3.

### 4.2 For Display Gradation Value Priority

### 4.2.1 Flowchart

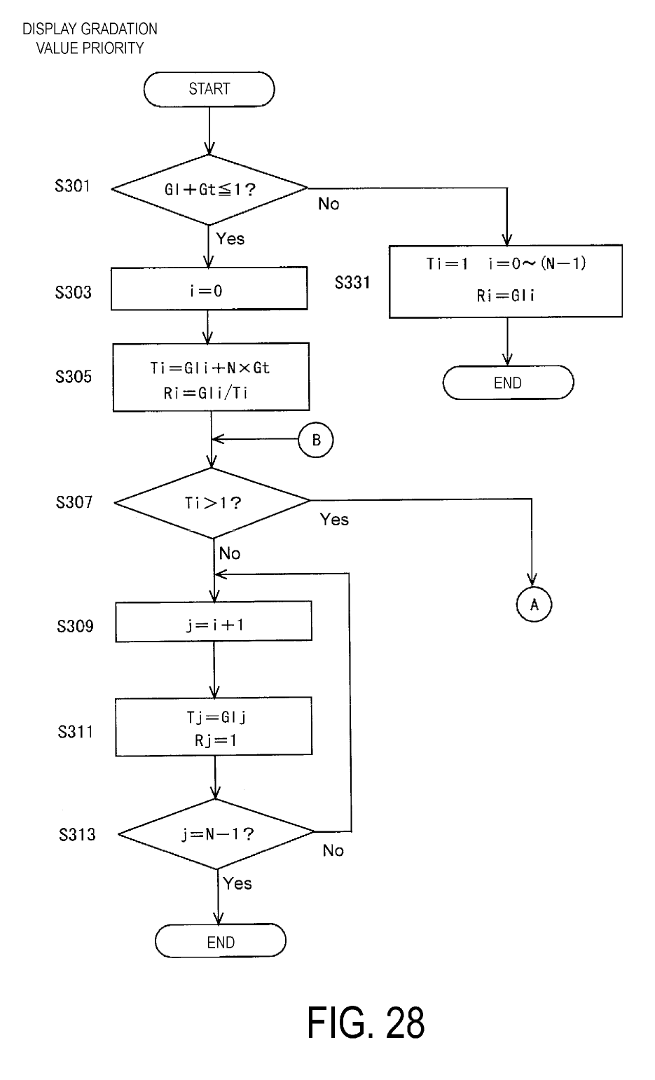

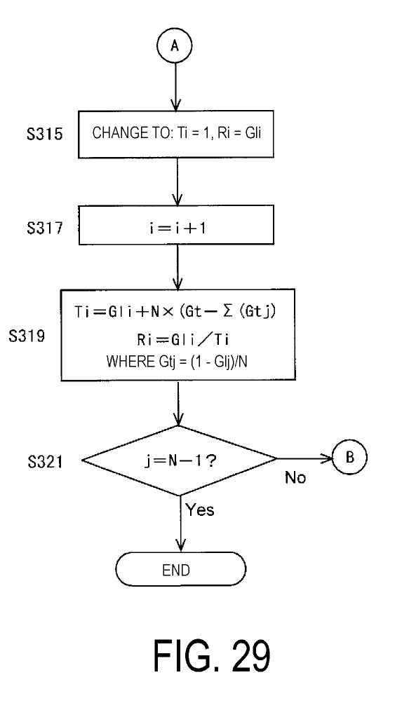

Next, procedure for obtaining selection ratios Ri (i=1 to (N−1)) 0 and transmittances Ti in fields in a case of display gradation value priority is described with reference to flowcharts. FIGS. 28 and 29 are flowcharts illustrating procedure for obtaining the selection ratios Ri and the transmittances Ti in the case of the display gradation value priority in the present embodiment. The third embodiment corresponds to the generalized second embodiment, so that the description is given in comparison with the flowcharts of the second embodiment.

As seen from FIGS. 28 and 29, the flowcharts of the display gradation value priority differ from the flowcharts of the transparency gradation value priority only in Step S331. As a result of determination whether a total value of the display gradation average value Gl and the transparency gradation value Gt satisfies Relationship (6) described above in Step S301, in a case where it is determined that the total value does not satisfy Relationship (6) (in a case where it is determined NO), the processing proceeds to Step S331. In Step S331, the transmittance Ti in each of fields 0 to (N−1) is obtained by Equation (79) similarly to the case of the transparency gradation value priority. The selection ratio Ri in each of fields 0 to (N−1) is obtained by Equation (81) below generalized from Equations (65a) to (65c), and then, the processing is terminated.

Ri=Gli(i=0˜(N−1)) (81)

The other Steps S301 to S321 are the same as the corresponding steps in the flowcharts of the transparency gradation value priority. Thus, the same reference numerals as those in the corresponding flowchart are denoted, and their description will be omitted.

### 4.2.2 Display State

A case where the flowcharts of the above-described N fields is applied to the case of the four fields is described. In the four fields, each of the white light source light, the red light source light, the green light source light, and the blue light source tight is radiated one after another, similarly to the case of the transparency gradation value priority.

A change of an image or a background displayed when being adjusted according to the transparency gradation value priority as the transparency gradation value increases in a case where a color of the light source light emitted from the backlight light source 50 changes by every of fields by field sequential driving is described. FIG. 30 is a diagram illustrating transmission states of the light source light and the background light when the display gradation values and the transparency gradation value are adjusted according to the display gradation value priority. FIG. 30 displays changes of a selection ratio of the selection ratio adjustment panel 35, a transmittance of the transmittance adjustment panel 36, and a display state of the transmittance adjustment panel 36 by 5 stages that are states P61 to P65 as the transparency gradation value changes. Note that the transparency gradation value Gt and the display gradation values Gl0 to Gl3 in fields 0 to 3 are the same as those in the case of the transparency gradation value priority illustrated in FIG. 27. Thus, their description will be omitted. The states P61 to P64 are the same as the states P51 to P54 of the transparency gradation value priority, respectively. Thus, their description will be omitted.

In the state P65, the display gradation average value Gl is “0.25” and the transparency gradation value Gt is “1”. In Step S301, it is therefore determined that (Gl+Gt) is greater than “1”, and the processing proceeds to Step S331. In field 0, the display gradation value Gl0 is “0.5”, the transparency gradation value Gt0 is “0.5”, and the non-transmission Gn0 is “0”. As a result, the image and the background overlapping each other are displayed in field 0. In field 1, the display gradation value Gl1 is “0.3”, the transparency gradation value Gt1 is “0.7”, and the non-transmission Gn1 is “0”. As a result, the image and the background overlapping each other are displayed also in field 1. In field 2, the display gradation value Gl2 is “0.1”, the transparency gradation value Gt2 is “0.9”, and the non-transmission Gn2 is “0”. As a result, the image and the background overlapping each other are displayed also in field 2. In field 3, the display gradation value Gl3 is “0.1”, the transparency gradation value Gt3 is “0.9”, and the non-transmission Gn3 is “0”. As a result, the image and the background overlapping each other are displayed also in field 3.

### 4.3 Effects

According to the present embodiment, even when an image specified by the display gradation values and the transparency gradation value included in the image information signal is not within a displayable range in the liquid crystal display device that displays a color image formed by the N fields, the display gradation values and the transparency gradation value can be adjusted by prioritizing the transparency gradation value or prioritizing the display gradation values. In this way, the liquid crystal display device can display a color image, make a background transparent to be displayed, and display a color image and a background overlapping each other regardless of whether the image specified by the display gradation values and the transparency gradation value is within the displayable range.

By further adding the white field as the color mixture field to the red, green, and blue fields, color breakup that is likely to occur when an observer suddenly moves his/her line of sight can be suppressed.

### 4.4 Modification

In the above-described embodiment, the white field is added as the color mixture field. However, a yellow field may be added instead of the white field. Yellow contains a red component and a green component. Thus, a yellow display gradation value is set to be a gradation value less than or equal to a smaller display gradation value of the red and green display gradation values. The display gradation values obtained by subtracting the yellow display gradation value from the red and green display gradation values are set as new red and green display gradation values, respectively. In this case, the blue display gradation value remains unchanged.

Alternatively, a cyan field may be added as the color mixture field. When the cyan field is added, a cyan display gradation value is set to be a gradation value less than or equal to a smaller display gradation value of the green and blue display gradation values. The display gradation values obtained by subtracting the cyan display gradation value from the green and blue display gradation values are set as new green and blue display gradation values, respectively. In this case, the red display gradation value remains unchanged.

Alternatively, a magenta field may be added as the color mixture field. When the magenta field is added, a magenta display gradation value is set to be a gradation value less than or equal to a smaller display gradation value of the red and blue display gradation values. The display gradation values obtained by subtracting the magenta display gradation value from the red and blue display gradation values are set as new red and blue display gradation values, respectively. In this case, the green display gradation value remains unchanged.

### 5. Fourth Embodiment

A configuration of a liquid crystal display device according to a fourth embodiment of the present invention is the same as the liquid crystal display device according to the second embodiment. The liquid crystal display device according to the fourth embodiment can display a color image by field sequential driving. However, the liquid crystal display device according to the fourth embodiment differs from the liquid crystal display device according to the second embodiment in that transparency gradation values included in an image information signal are “0” or “1”. Note that the flowcharts in the case of the transparency gradation value priority is the same as the flowcharts illustrated in FIGS. 17 and 18 except for that states of pixels only include a state P71 and a state P75. The flowcharts in the case of the display gradation value priority is the same as the flowcharts illustrated in FIGS. 21 and 22 except for that states of pixels only include a state P81 and a state P85. Thus, the flowcharts and their description will be omitted in the present embodiment.

### 5.1 For Transparency Gradation Value Priority

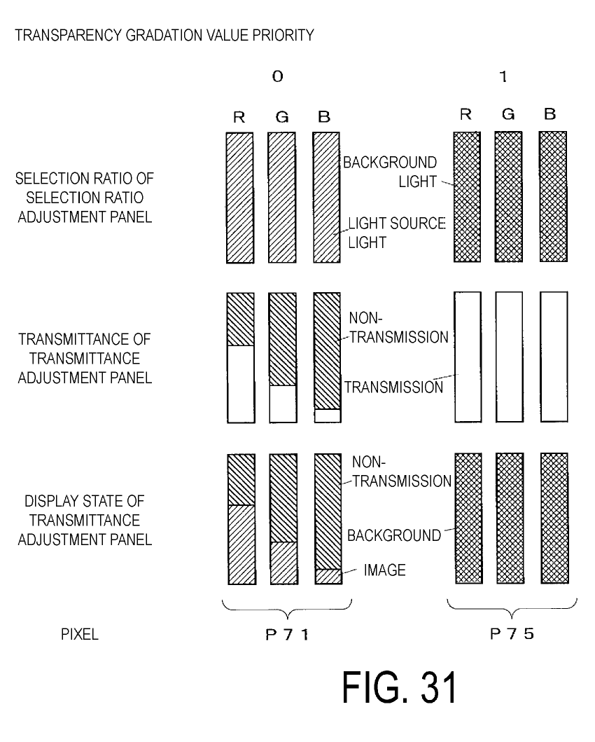

FIG. 31 is a diagram illustrating transmission states of the light source light and the background light when the display gradation values and the transparency gradation value are adjusted according to the transparency gradation value priority. In FIG. 31, a transparency gradation, a selection ratio of the selection ratio adjustment panel 35, a transmittance of the transmittance adjustment panel 36, and a display state of the transmittance adjustment panel 36 are displayed vertically for each of the fields in the states P71 and P75 including different transparency gradation values.

A change of a display state when being adjusted according to the transparency gradation value priority in a case where a color of the light source light emitted from the backlight light source 50 changes for each of fields by field sequential driving is described. In FIG, 31, the display gradation value Gl0, the display gradation value Gl1, and the display gradation value Gl2 in fields 0 to 2 are “0.6”, “0.3”, and “0.1”, respectively, regardless of a value of the transparency gradation value Gt in the states P71 and P75. In this way, the display gradation average value Gl in fields 0 to 2 is “0.33” from Equation (21). The transparency gradation value in the state P71 is “0” and the transparency gradation value in the state P75 is “1”.

In the state P71, the display gradation average value Gl is “0.33” and the transparency gradation value Gt is “0”. In Step S201, it is determined that (Gl+Gt) is less than or equal to “1”, and the processing proceeds to Step S203. In field 0, the selection ratio R0 is “1” and the transmittance T0 is “0.6” from Equation (3) and Equation (4) described above, respectively. Thus, the display gradation value Gl0 is “0.6” and the transparency gradation value Gt0 is “0” from Equations (1) and (2), respectively, and the non-transmission Gn0 is “0.4” from Equation (5). As a result, only the image is displayed in field 0.

In field 1, the selection ratio R1 is “1” and the transmittance T1 is “0.3” from Equation (3) and Equation (4) described above, respectively, Thus, the display gradation value G11 is “0.3” and the transparency gradation value Gtl is “0” from Equations (1) and (2), respectively, and the non-transmission Gnl is “0.7” from Equation (5). As a result, only the image is displayed also in field 1.

In field 2, the selection ratio R2 is “1” and the transmittance T2 is “0.1” from Equation (3) and Equation (4) described above, respectively. Thus, the display gradation value G12 is “0.1” and the transparency gradation value Gt2 is “0” from Equations (1) and (2), respectively, and the non-transmission Gn2 is “0.9” from Equation (5). As a result, only the image is displayed also in field 2.

In the state P75, the display gradation average value Gl is “0.33” and the transparency gradation value Gt is “1”. In Step S201, it is determined that (Gl+Gt) is greater than “1”, and thus the processing proceeds to Step S203. The method for obtaining a selection ratio and a transmittance in each of fields 0 to 2 is the same as or similar to the method for obtaining a selection ratio and a transmittance described in the state P71, thus, only the results are described below. In field 0, the display gradation value Gl0 is “0”, the transparency gradation value Gt0 is “1”, and the non-transmission Gn0 is “0”. As a result, only the background is displayed in field 0. In field 1, the display gradation value Gl1 is “0”, the transparency gradation value Gt1 is “1”, and the non-transmission Gn1 is “0”. As a result, only the background is displayed also in field 1, In field 2, the display gradation value Gl2 is “0”, the transparency gradation value Gt2 is “1”, and the non-transmission Gn2 is “0”. As a result, only the background is displayed also in field 2.

### 5.2 For Display Gradation Value Priority

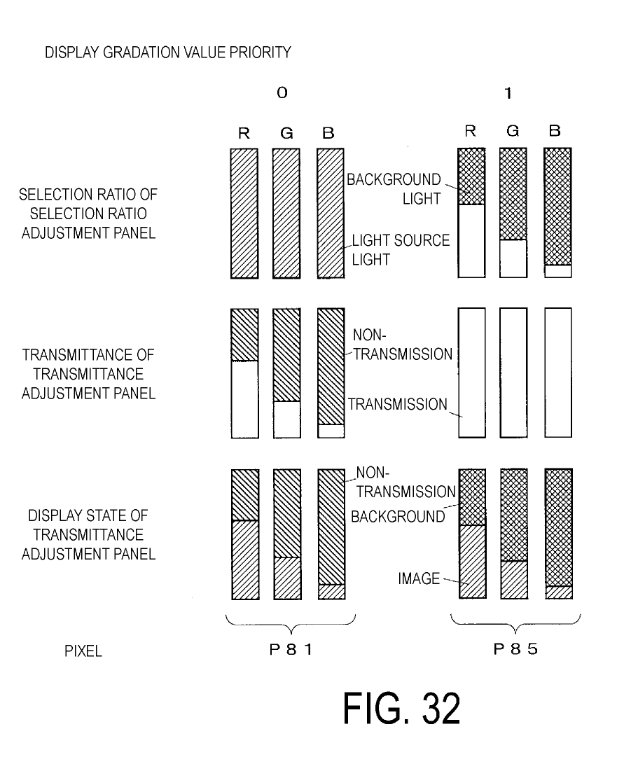

FIG. 32 is a diagram illustrating transmission states of the light source light and the background light when the display gradation values and the transparency gradation value are adjusted according to the display gradation value priority. In FIG. 32, a transparency gradation, a selection ratio of the selection ratio adjustment panel 35, a transmittance of the transmittance adjustment panel 36, and a display state of the transmittance adjustment panel 36 are displayed vertically for each of the fields in states P81 and P85 including different transparency gradation values.

A change of a display state when being adjusted according to the transparency gradation value priority in a case where a color of the light source light emitted from the backlight light source 50 changes for each of fields by field sequential driving is described. In FIG. 32, the display gradation values Gl0 to Gl2 in respective fields 0 to 2 in the states P81 and P85 are the same as those in the case illustrated in FIG. 31. The transparency gradation value in the state P81 is “0” and the transparency gradation value in the state P85 is “1”.

In the state P81, the display gradation average value Gl is “0.33” and the transparency gradation value (it is “0”. In Step S201, it is determined that (Gl+Gt) is less than or equal to “1”, and the processing proceeds to Step S203. In field 0, the selection ratio R0 is “1” and the transmittance T0 is “0.6” from Equation (3) and Equation (4) described above, respectively. Thus, the display gradation value G10 is “0.6” and the transparency gradation value Gt0 is “0” from Equations (1) and (2), respectively, and the non-transmission Gn0 is “0.4” from Equation (5). As a result, only the image is displayed in field 0. Similarly, in field 1, the display gradation value Gl1 is “0.3”, the transparency gradation value Gt1 is “0”, and the non-transmission Gn1 is “0.7”. As a result, only the image is displayed also in field 1. In field 2, the display gradation value Gl2 is “0.1”, the transparency gradation value Gt2 is “0”, and the non-transmission Gn2 is “0.9”. As a result, only the image is displayed also in field 2.

In the state P85, the display gradation average value Gl is “0.33” and the transparency gradation value Gt is “1”. In Step S201, it is determined that (Gl+Gt) is greater than “1”, and thus the processing proceeds to Step S203. The method for obtaining selection ratios R0 to R2 and transmittances T0 to T2 in respective fields 0 to 2 is the same as or similar to the method for obtaining selection ratios R0 to R2 and transmittances T0 to T2 described in the state P71, thus, only the results are described below. In field 0, the display gradation value G10 is “0.6”, the transparency gradation value Gt0 is “0.4”, and the non-transmission Gn0 is “0”. As a result, the image and the background overlapping each other are displayed in field 0. In field 1, the display gradation value G11 is “0.3”, the transparency gradation value Gt1 is “0.7”, and the non-transmission Gn1 is “0”. As a result, the image and the background overlapping each other are displayed also in field 1. In field 2, the display gradation value Gl2 is “0.1”, the transparency gradation value Gt2 is “0.9”, and the non-transmission Gn2 is “0”. As a result, the image and the background overlapping each other are displayed also in field 2.

The case of field sequential driving formed of the three fields of field 0 to field 2 is described in the present embodiment. However, the present embodiment is also similarly applicable to the case of field sequential driving formed of four or more fields.

### 5.3 Effects

The present embodiment can also achieve the same or similar effects to the effects in the second embodiment. Because the transparency gradation value is “0” or “1” in the image information signal, capacity of the image information signal including the transparency gradation value can be reduced. This can reduce the size of the drive control circuit unit that performs signal processing on the image information signal in the liquid crystal display device. Thus, manufacturing costs of the liquid crystal display device can be reduced.

### 6. Other Configuration of Liquid Crystal Display Device

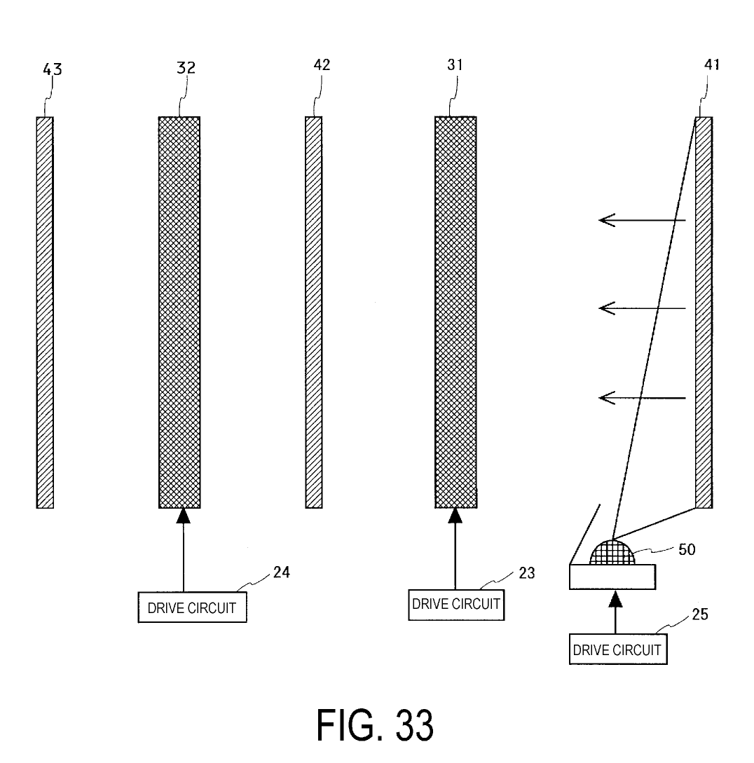

FIG. 33 is a diagram illustrating a configuration of a display unit included in a liquid crystal display device according to a first modification, which can be used in the present invention. As illustrated in FIG. 33, in the display unit in the liquid crystal display device according to the first modification, a reflection polarizing plate 41, a first liquid crystal panel 31, a first absorption polarizing plate 42, a second liquid crystal panel 32, and a second absorption polarizing plate 43 are disposed in parallel to each other in the stated order from the back side to the front side. A backlight light source 50 is disposed near a space sandwiched between the first liquid crystal panel 31 and the reflection polarizing plate 41. Light emitted from the backlight tight source 50 is radiated on the reflection polarizing plate 41. Light reflected by the reflection polarizing plate 41 of the light emitted from the backlight light source 50 enters the first liquid crystal panel 31 as light source light. The subsequent operations of the light source light and background light that enters from the back side are the same as those in each of the above-described embodiments. Thus, their description wilt be omitted. A first liquid crystal panel drive circuit 23 is connected to the first liquid crystal panel 31. A second liquid crystal panel drive circuit 24 is connected to the second liquid crystal panel 32. A backlight light source drive circuit 25 is connected to the backlight light source 50.

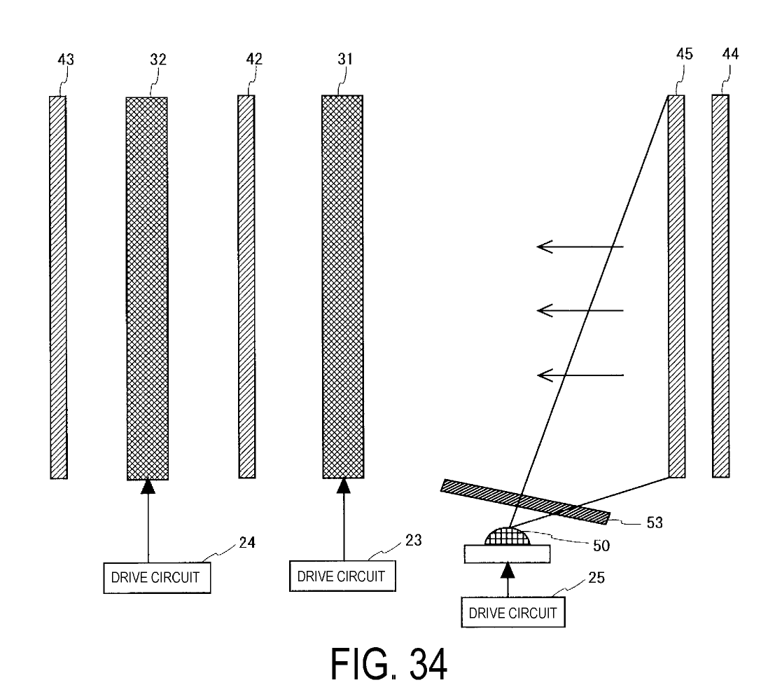

FIG. 34 is a diagram illustrating a configuration of a display unit included in a liquid crystal display device according to a second modification, which can be used in the present invention. As illustrated in FIG. 34, in the display unit in the liquid crystal display device according to the second modification, an absorption polarizing plate 44, a diffraction grating sheet 45, a first liquid crystal panel 31, a first absorption polarizing plate 42, a second liquid crystal panel 32, and a second absorption polarizing plate 43 are disposed in parallel to each other in the stated order from the back side to the front side. A backlight tight source 50 and an absorption polarizing plate 53 are disposed near a space sandwiched by the first liquid crystal panel 31 and the diffraction grating sheet 45. Thus, based on application of single polarization light transmitted through the absorption polarizing plate 53, the diffraction grating sheet 45 reflects the single polarization tight. The single polarization tight enters the first liquid crystal panel 31 as light source light. The subsequent operations of the light source light and background light that enters from the back side are the same as those in each of the above-described embodiments. Thus, their description wilt be omitted. A first liquid crystal panel drive circuit 23 is connected to the first liquid crystal panel 31. A second liquid crystal panel drive circuit 24 is connected to the second liquid crystal panel 32. A backlight light source drive circuit 25 is connected to the backlight tight source 50. The backlight light source 50 and the absorption polarizing plate 53 may be collectively referred to as a “display tight-emitting tight source”. The absorption polarizing plate 44 and the diffraction grating sheet 45 may be collectively referred to as a “radiation plate”.

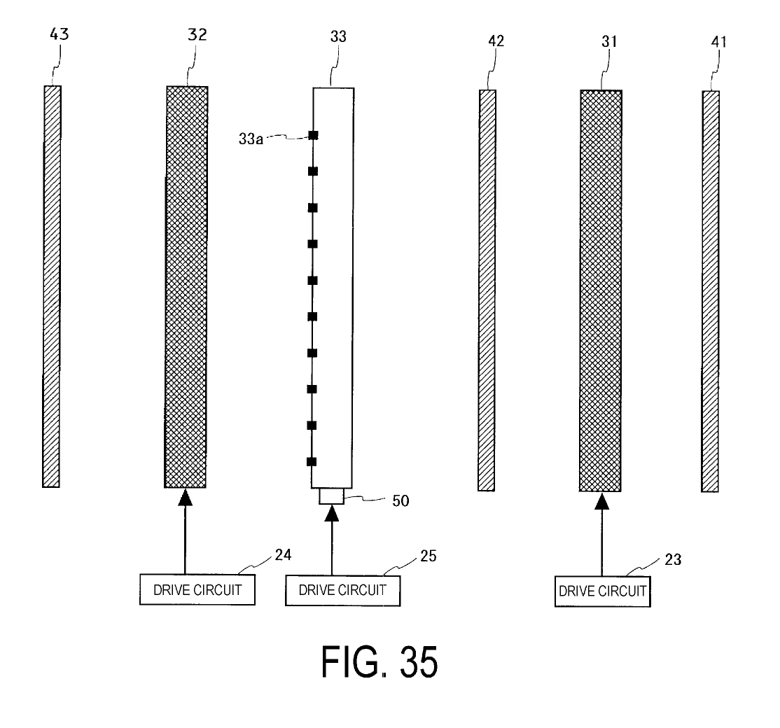

FIG. 35 is a diagram illustrating a configuration of a display unit included in a liquid crystal display device according to a third modification, which can be used in the present invention. As illustrated in FIG. 35, in the display unit in the liquid crystal display device according to the third modification, a reflection polarizing plate 41, a first liquid crystal panel 31, a first absorption polarizing plate 42, a light guide plate 33 on which a backlight tight source 50 is mounted, a second liquid crystal panel 32, and a second absorption polarizing plate 43 are disposed in parallel to each other in the stated order from the back side to the front side, The light guide plate 33 is an asymmetric light guide plate including a reflector 33a on a surface on the front side. Accordingly, light emitted from the backlight light source 50 is emitted mainly toward the back side. A polarization direction of polarization components of light transmitted through the first absorption polarizing plate 42 is rotated 90° by the first liquid crystal panel 31 or not rotated and enters the reflection polarizing plate 41. The reflection polarizing plate 41 reflects the polarization components having the same polarization direction as a direction of a reflection axis of the reflection polarizing plate 41 toward the front side. Furthermore, the reflection polarizing plate 41 allows the transmission of the polarization components of the background light, which enters from the back side, in the same polarization direction as a direction of a transmission axis of the reflection polarizing plate 41. Thus, the polarization direction of the polarization components in the light source light entering the first liquid crystal panel 31 and the polarization direction of the polarization components in the background light are orthogonal to each other. The subsequent operations of the tight source light and background light are the same as those in each of the above-described embodiments. Thus, their description will be omitted. A first liquid crystal panel drive circuit 23 is connected to the first liquid crystal panel 31. A second liquid crystal panel drive circuit 24 is connected to the second liquid crystal panel 32. A backlight light source drive circuit 25 is connected to the backlight light source 50.

### INDUSTRIAL APPLICABILITY

The present invention is suitable for a display device such as an active matrix liquid crystal display device. The present invention is especially suitable for a display device that allows a background to be transparent.

### REFERENCE SIGNS LIST

21 Image information signal conversion circuit

22 Drive timing adjustment circuit

31 First liquid crystal panel

32 Second liquid crystal panel

33 Light guide plate

35 Selection ratio adjustment panel

36 Transmittance adjustment panel

41 Reflection polarizing plate (radiation plate)

42 First absorption polarizing plate

43 Second absorption polarizing plate

50 Backlight light source (display light-emitting light source)

51 Lamp (light-emitting device)

DAT Image information signal

Gl Display gradation average value

Gt Transparency gradation value

R Selection ratio of selection ratio adjustment panel

T Transmittance of transmittance adjustment panel

1. A display device serving as a transparent display, the display device comprising:
an image information signal conversion circuit configured to obtain a selection ratio and a transmittance based on a display gradation value indicating a display gradation of an image and a transparency gradation value indicating transparency, the display gradation value and the transparency gradation value being included in an image information signal provided from the outside;
a display light-emitting light source configured to emit light source light;
a selection ratio adjustment panel configured to allow transmission of the light source light emitted from the display light-emitting light source and background light entering from a back side of the display device in proportions determined by the selection ratio; and
a transmittance adjustment panel configured to allow transmission of at least the light source light or the background light at the transmittance, the light source light and the background light being transmitted through the selection ratio adjustment panel,
wherein the image information signal conversion circuit includes
a calculation unit configured to calculate a total value of the display gradation value and the transparency gradation value,
a displayable range determination unit configured to determine whether the total value calculated by the calculation unit is greater than 1, and
a gradation correction computing unit configured to obtain the selection ratio and the transmittance by using the transparency gradation value and the display gradation value according to transparency gradation value priority adjusting the display gradation value without changing the transparency gradation value or display gradation value priority adjusting the transparency gradation value without changing the display gradation value when the displayable range determination unit determines that the total value is greater than 1, and
the transparent display is configured to display at least an image or a background in proportions determined by the selection ratio and the transmittance.

2. The display device according to claim 1,
wherein the gradation correction computing unit is configured to obtain the transmittance as 1 and the selection ratio based on the transparency gradation value when the selection ratio and the transmittance are obtained according to the transparency gradation value priority.

3. The display device according to claim 1,
wherein the gradation correction computing unit is configured to obtain the transmittance as 1 and the selection ratio as a value equal to the display gradation value when the selection ratio and the transmittance are obtained according to the display gradation value priority.

4. The display device according claim 1,
wherein the gradation correction computing unit is configured to obtain the transmittance and the selection ratio by the same processing procedure based on the display gradation value and the transparency gradation value in both cases of the display gradation value priority and the transparency gradation value priority when the displayable range determination unit determines that the total value is less than or equal to 1.

5. The display device according to claim 1,
wherein the light source light emitted from the display light-emitting light source is monochromatic light.

6. The display device according to claim 1,
wherein the display light-emitting light source is configured to emit the light source light in different colors one after another in time division manner for respective fields, and
the gradation correction computing unit is configured to obtain the selection ratio and the transmittance based on the transparency gradation value and the display gradation value corresponding to colors of the light source light for each of the fields.

7. The display device according to claim 6,
wherein the plurality of fields further include a color mixture field in which the display light-emitting light source simultaneously emits light source light in at least two or more colors of the light source light from the different colors, and
the gradation correction computing unit is configured to adjust the selection ratio and the transmittance to obtain the display gradation value in the color mixture field less than or equal to a minimum display gradation value among the display gradation values of colors of the light source light.

8. The display device according to claim 6,
wherein the transparency gradation value included in the image information signal is 0 or 1.

9. The display device according to claim 1,
wherein the selection ratio adjustment panel includes a first liquid crystal panel and a first absorption polarizing plate adhering to a front surface of the first liquid crystal panel,
the transmittance adjustment panel includes a second liquid crystal panel and a second absorption polarizing plate adhering to a front surface of the second liquid crystal panel,
the first liquid crystal panel is configured to allow transmission of a polarization component having the same polarization direction as a direction of a transmission axis among polarization components of the light source light and/or the background light based on the selection ratio to enter the polarization component to the second liquid crystal panel, and
the second liquid crystal panel is configured to allow transmission of a polarization component having the same polarization direction as a direction of a transmission axis among polarization components of the light source light and/or the background light to a front side based on the transmittance.

10. The display device according to claim 9 further comprising:
a radiation plate configured to radiate the light source light emitted from the display light-emitting light source toward the front side while allowing transmission of the background light to the front side,
wherein the radiation plate is configured to enter the light source light and the background light to the first liquid crystal panel, a polarization direction of the light source light and a polarization direction of the background light being orthogonal to each other.

11. A display method for displaying at least an image or a background on a display device serving as a transparent display, the display device comprising:
an image information signal conversion circuit configured to obtain a selection ratio and a transmittance based on a display gradation value indicating a display gradation of an image and a transparency gradation value indicating transparency, the display gradation value and the transparency gradation value being included in an image information signal provided from the outside;
a display light-emitting light source configured to emit light source light;
a selection ratio adjustment panel configured to allow transmission of the light source light emitted from the display light-emitting light source and background light entering from a back side of the display device in proportions determined by the selection ratio; and
a transmittance adjustment panel configured to allow transmission of at least the light source light or the background light at the transmittance, the light source light and the background light being transmitted through the selection ratio adjustment panel,
the display method comprising:
calculating that calculates a total value of the display gradation value and the transparency gradation value,
displayable range determining that determines whether the total value calculated by the calculation unit is greater than 1, and
gradation correction computing that obtains the selection ratio and the transmittance by using the transparency gradation value and the display gradation value according to transparency gradation value priority adjusting the display gradation value without changing the transparency gradation value or display gradation value priority adjusting the transparency gradation value without changing the display gradation value when the displayable range determination unit determines that the total value is greater than 1.
